(19) United States
(12) Patent Application Publication
(10) Pub. No.: US 2017/0242376 A1
(43) Pub. Date: Aug. 24, 2017

(54) IMAGE HEATING APPARATUS

(71) Applicant: CANON KABUSHIKI KAISHA, Tokyo (JP)

(72) Inventors: Masahiro Tsujibayashi, Nagareyama-shi (JP); Nobuhiro Kikuchi, Moriya-shi (JP)

(21) Appl. No.: 15/476,407

(22) Filed: Mar. 31, 2017

Related U.S. Application Data
(63) Continuation of application No. PCT/JP2015/078698, filed on Oct. 2, 2015.

(30) Foreign Application Priority Data
Oct. 3, 2014 (JP) 2014-204433
Oct. 3, 2014 (JP) 2014-204434

(51) Int. Cl. G03G 15/20

(52) U.S. Cl. CPC G03G 15/2039

(57) ABSTRACT

The present invention relates to temperature control of an external heating belt. A controller is capable of executing a mode in which energization to corresponding halogen heaters is controlled using outputs of respective thermistors and a mode in which the energization to the two halogen heaters is controlled using the output of the other thermistor without using the output of one thermistor.

### TECHNICAL FIELD

The present invention relates to an image heating apparatus, used in an electrophotographic (type) image forming apparatus such as a copying machine, a printer, a multi-function machine or a facsimile machine, for heating a toner image on a recording material.

### BACKGROUND ART

In the image forming apparatus of the electrophotographic type or the like, the toner image is fixed on the recording material by heating and pressing the toner image formed on the recording material by a fixing device (image heating apparatus). In the fixing device, a pair of rotatable members is provided, and at a nip therebetween, fixing of the toner image is carried out.

In the case where the toner image is fixed on the recording material, heat is transferred from the rotatable members to the recording material, so that a surface temperature of the rotatable members lowers.

Therefore, a type in which the rotatable member is externally heated in addition to interval heating of the rotatable members has been proposed (Japanese Laid-Open Patent Application 2012-2926). Specifically, the rotatable member is heated using an external heating belt (endless belt) stretched by two rollers. In the two rollers, heaters are incorporated, respectively, and two temperature sensors are provided opposed to the respective rollers via the external heating belt.

In such a fixing device, in a heating region where the external heating belt and the rotatable member contact each other, heat supply from the external heating belt to the rotatable member is carried out. For that reason, there is a tendency that compared with a temperature of the external heating belt in an upstream side of the heating region, the temperature of the external heating belt in a downstream side of the heating region lowers.

In a constitution exhibiting such a tendency, it is required that the external heating belt is controlled to a proper temperature.

### SUMMARY OF THE INVENTION

According to the present invention, there is provided an image heating apparatus comprising: a first rotatable member and a second rotatable member for forming a nip for heating a toner image on a recording material; an endless belt for heating the first rotatable member in contact with an outer surface of the first rotatable member; a first roller and a second roller, which are provided inside the endless belt in the order named along a rotational direction of the first rotatable member, for supporting the endless belt; a first heater for heating the first roller; a second heater for heating the second roller; a first sensor for detecting a temperature of a region of the endless belt supported by the first roller; a second sensor for detecting a temperature of a region of the endless belt supported by the second roller; and a controller for controlling energization to the first heater and the second heater, wherein the controller is capable of executing a first mode in which the energization to the first heater is controlled using an output of the first sensor and the energization to the second heater is controlled using an output of the second sensor and a second mode in which the energization to the first heater and the second heater is controlled using the output of the first sensor without using the output of the second sensor.

### BRIEF DESCRIPTION OF THE DRAWINGS

FIG. 1 is a schematic illustration of an image forming apparatus to which a fixing device according to First Embodiment is applied.

FIG. 2 is a schematic illustration of the fixing device in First Embodiment.

FIG. 3 is a block diagram of a control system of the fixing device in First Embodiment.

FIG. 4 is a graph showing time progressions of a fixing roller temperature, an external heating upstream temperature and an external heating downstream temperature in a comparison example.

FIGS. 5, 5A, and 5B depict a flowchart showing control of the fixing device in First Embodiment.

FIG. 6 is a graph showing time progressions of a fixing roller temperature, an external heating upstream temperature and an external heating downstream temperature in First Embodiment.

FIG. 7 is a graph showing a difference in detection temperature between a thermistor in an upstream side with respect to a rotational direction of a fixing roller and a thermistor in a downstream side with respect to the rotational direction of the fixing roller.

FIG. 8 is an illustration showing a relationship between a turning-on duty and an energization time of a halogen heater.

FIGS. 9, 9A, and 9B depict a flowchart showing control of a fixing roller in Second Embodiment.

FIG. 10 is an illustration showing a time progression of a fixing roller temperature in the case where a feeding interval of a recording material is increased.

FIG. 11 is a graph showing a difference in detection temperature between a thermistor in an upstream side with respect to a rotational direction of a fixing roller and a thermistor in a downstream side with respect to the rotational direction of the fixing roller.

FIGS. 12, 12A, and 12B depict a flowchart showing control of a fixing device in Third Embodiment.

FIG. 13 is a graph showing time progressions of a fixing roller temperature, an external heating upstream temperature and an external heating downstream temperature in a comparison example.

FIGS. 14, 14A, and 14B depict a flowchart showing control of the fixing device in Fourth Embodiment.

FIG. 15 is a graph showing a time progression of a fixing roller temperature in Fourth Embodiment.

FIGS. 16, 16A, and 16B depict a flowchart showing control of a fixing device in Fifth Embodiment.

FIGS. 17, 17A, and 17B depict a flowchart showing control of a fixing device in Sixth Embodiment.

### EMBODIMENTS FOR CARRYING OUT THE INVENTION

### First Embodiment

### [Image Forming Apparatus]

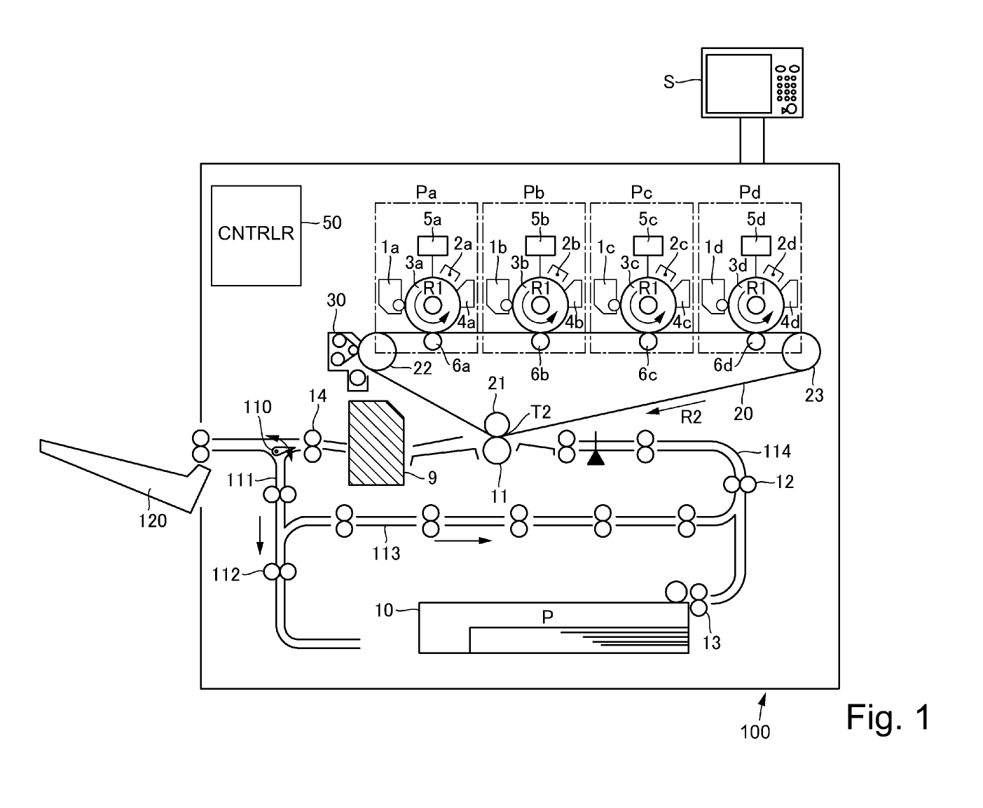

An fixing device according to First Embodiment of the present invention will be described using FIGS. 1 to 6. First, an image forming apparatus to which the fixing device according to this embodiment is applicable will be described using FIG. 1. An image forming apparatus 100 shown in FIG. 1 is an intermediary transfer type full-color printer of a tandem type in which image forming portions Pa, Pb, Pc and Pd for yellow, magenta, cyan and black are arranged along an intermediary transfer belt 20.

First, a feeding process of a recording material in this image forming apparatus 100 will be described. The recording material P is accommodated in the form of being stacked in a recording material accommodating container (sheet feeding cassette) 10, and is fed by a feeding roller 13 by being timed to image forming timing. In sheet feeding from the recording material accommodating container 10, for example, a friction separation type or the like is used. The recording material P fed by the feeding roller 13 is fed to registration rollers 12 provided at a halfway portion of a feeding path 114. Further, the recording material P is sent to a secondary transfer portion T2 after oblique movement correction and timing correction of the recording material P are carried out in the registration roller 12. The secondary transfer nip T2 is a transfer nip formed by opposing inner secondary transfer roller 21 and outer secondary transfer roller 11, and the toner image is attracted onto the recording material by applying a predetermined pressing force and a predetermined electrostatic load bias.

Relative to the above-described feeding process of the recording material P to the secondary transfer portion T2, a forming process of the image sent to the secondary transfer portion T2 at similar timing will be described. First, the image forming portions are described, but the image forming portions Pa, Pb, Pc and Pd for the respective colors are substantially similarly constituted except that colors of the toners are yellow, magenta, cyan and black, which are different from each other. Therefore, in the following, as a representative, the image forming portion Pb for black is described, and as regards other image forming portions Pa, Pb and Pc, the suffix d of symbols in the description is to be described by being read as a, b and c.

The image forming portion Pd is principally constituted by a developing device 1d, a charging device 2d, a photosensitive drum 3d, a photosensitive drum cleaner 4d and an exposure device 5d and the like. In the figure, a surface of the photosensitive drum 3d rotationally driven in R1 direction is electrically charged uniformly in advance by the charging device 2d, and thereafter, an electrostatic latent image is formed by the exposure device 5d driven on the basis of a signal of image information. Then, the electrostatic latent image formed on the photosensitive drum 3d is subjected to toner development by the developing device 1d and is visualized. Thereafter, a predetermined pressing force and a predetermined electrostatic load bias are applied by a primary transfer roller 6d provided opposed to the image forming portion Pd by sandwiching the intermediary transfer belt 20 therebetween, so that the toner image formed on the photosensitive drum 3d is primary-transferred onto the intermediary transfer belt 20. Primary transfer residual toner remaining on the photosensitive drum 3d in a slight amount is collected by the photosensitive drum cleaner 4d and is prepares for a subsequent image forming process. As regards the image forming portion Pd described above, in the case of a structure shown in FIG. 1, four sets for yellow, magenta, cyan and black exist. However, the number of the colors is not limited to four (colors), and also an arrangement order of the colors is not limited thereto. The developing device 1d uses, as a developer, a two-component developer in which the toner and a magnetic carrier are mixed, for example.

The intermediary transfer belt 20 will be described. The intermediary transfer belt 20 is an endless belt which is stretched by the inner secondary transfer roller 21, a tension roller 22 and a stretching roller 23 and which is fed and driven in an arrow R2 direction in the figure. Here, the inner secondary transfer roller 21 also functions as a driving roller for driving the intermediary transfer belt 20. Image forming processes for the respective colors to be processed in parallel by the image forming portions P are carried out at timing when the toner images are successively superposed on the toner image(s) for the upstream(-side) color(s) primary-transferred on the intermediary transfer belt 20. As a result, finally, a full-color toner image is formed on the intermediary transfer belt 20 and is fed to the secondary transfer portion T2. Incidentally, secondary transfer residual toner after passed through the secondary transfer portion T2 is collected by a transfer cleaner device 30.

As described above, by the feeding process and the image forming process which are described, respectively, timing of the recording material P and timing of the full-color toner image coincide with each other, so that secondary transfer is carried out. Thereafter, the recording material P is fed to a fixing device 9 (image heating apparatus), and predetermined pressure and predetermined heat quantity are applied to the recording material P, so that the toner image is melt-fixed on the recording material. Thus, the recording material P on which the image is fixed is subjected to selection by discharging rollers 14 such that the recording material P is discharged onto a sheet discharge tray 120 or subjected to double-side image formation.

In the case where the double-side image formation is required, by a switching member 110 (called a flapper or the like), the feeding path is switched from a path leading to the sheet discharge tray 120 to a double-side feeding path 111, so that the recording material P fed by the sheet discharging rollers 14 is fed to the double-side feeding path 111. Thereafter, in synchronism with timing of a recording material P, in a subsequent job, fed from the feeding roller 13, leading and trailing ends of the recording material P (fed along the feeding path 112) are replaced with each other, and is sent again to the feeding path 114 via a double-side path 113. As regards subsequent feeding and image forming process on the back surface, they are similar to those described above, and therefore, description will be omitted.

Further, the image forming apparatus 100 includes an operating portion S and a controller 50. The operating portion S includes a display portion (not shown) of displaying various pieces of information, operating keys (not shown) through which user input is received, and the like. A user is capable of providing a start instruction of an image forming job by using the operation keys of the operating portion S or selectively inputting image quality setting of the image and the various species of information (for example, a type, a basis weight and the like of paper) of the recording material P set in the recording material accommodating container 10, from pieces of information displayed at the display portion. The controller 50 determines an image forming condition in accordance with inputted information, and controls respective portions of the image forming apparatus 100 in order to effect the image formation under the image forming condition. The controller 50 carries out control of the fixing device 9 during execution of the image forming job, so that the recording material P is heated at a predetermined temperature and the toner image is heat-fixed. As regards the control of such a fixing device 9, description is made layer, and therefore, detailed description will be omitted here.

### [Fixing Device]

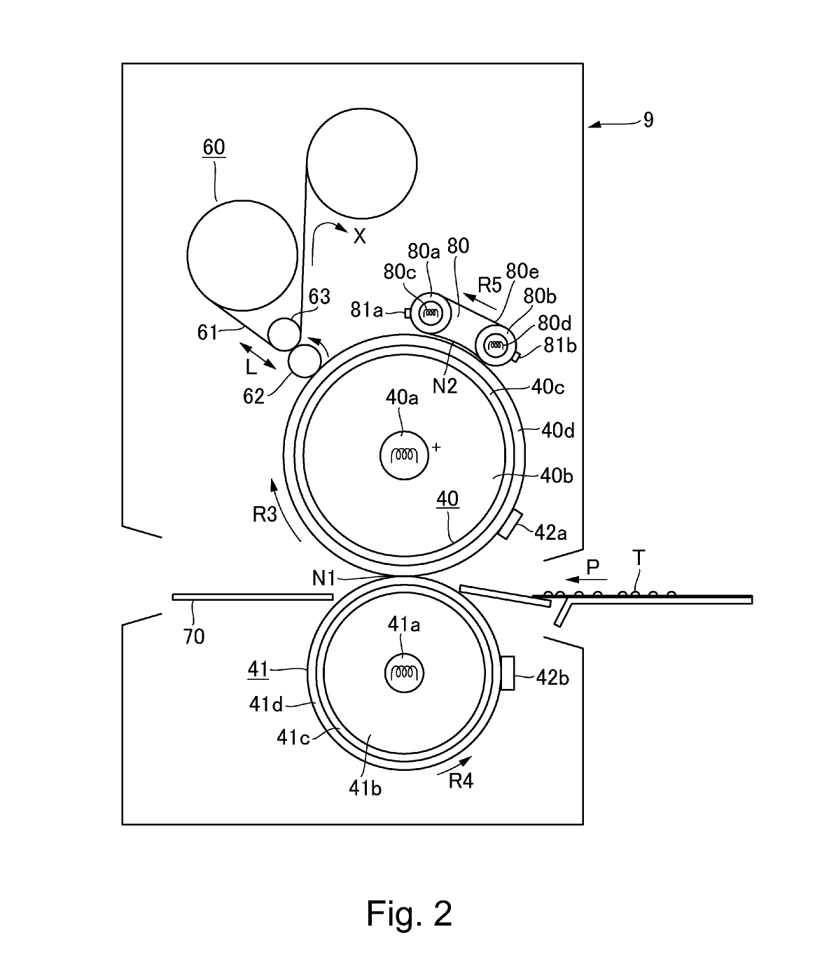

Next, a structure of the fixing device 9 will be described using FIG. 2. The fixing device 9 includes a fixing roller 40 as a first rotatable member and a pressing roller 41 as a second rotatable member. The fixing roller 40 and the pressing roller 41 are rotatably shaft-supported by a housing (not shown) of the fixing device 9 via ball bearings (not shown) or the like. The fixing roller 40 and the pressing roller 41 are omitted from illustration in the figure, but gears fixed to one shaft ends thereof are connected with each other via a gear mechanism, and are integrally rotationally driven by a driving source (not shown) such as a motor via the gear mechanism.

The fixing roller 40 is formed by superposing a heat-resistant elastic layer 40c and a heat-resistant parting layer 40d, from an inner diameter side in the order named, on a metal-made core metal 40b formed in a cylindrical shape. For example, the core metal 40b of the fixing roller 40 is made of aluminum of 77 mm in outer diameter, 6 mm in thickness and 350 mm in length. The elastic layer 40c is formed with a 3 mm-thick HTV (high-temperature vulcanization type) silicone rubber, and coats an outer peripheral surface of the core metal 40b. The parting layer 40d is formed with a 50 μm-thick fluorine-containing resin material (for example, a PFA tube) in order to improve a parting property and coats a surface of the elastic layer 40c.

At an inner portion of the core metal 40b of the fixing roller 40, a halogen heater 40a of, e.g., 1200 W in normal rated power, which is subjected to output control by energization and which thus generates heat is provided non-rotatably almost over an entirety of the fixing roller 40 with respect to a widthwise direction (longitudinal direction, axial direction). The halogen heater 40a heats the fixing roller 40 from an inside of the fixing roller 40 so that a surface temperature of the fixing roller 40 is a predetermined target temperature. The surface temperature of the fixing roller 40 is detected by a thermistor 42a. Then, on the basis of this detection temperature, the halogen heater 40a is subjected to ON (energization) or OFF (non-energization) control by the controller 50 (see FIG. 1), so that the surface temperature of the fixing roller 40 is adjusted to the predetermined target temperature.

The pressing roller 41 is formed by superposing a heat-resistant elastic layer 41c and a heat-resistant parting layer 41d, from an inner diameter side in the order named, on a metal-made core metal 41b formed in a cylindrical shape. For example, the core metal 41b of the pressing roller 41 is made of aluminum of 59 mm in outer diameter, 5 mm in thickness and 350 mm in length. The elastic layer 41c is formed with a 1 mm-thick HTV silicone rubber, and coats an outer peripheral surface of the core metal 41b. The parting layer 41d is formed with a 50 μm-thick fluorine-containing resin material (for example, a PFA tube) and coats a surface of the elastic layer 41c.

At an inner portion of the core metal 41b of the pressing roller 41, a halogen heater 41a of, e.g., 400 W in normal rated power, which generates heat by energization is provided non-rotatably almost over an entirety of the pressing roller 41 with respect to a widthwise direction (longitudinal direction, axial direction). The halogen heater 41a heats the pressing roller 41 from an inside of the pressing roller 41 so that a surface temperature of the pressing roller 41 is a predetermined target temperature. The surface temperature of the pressing roller 41 is detected by a thermistor 42b. Then, on the basis of this detection temperature, the halogen heater 41a is subjected to the ON-OFF control by the controller 50 (see FIG. 1), so that the surface temperature of the pressing roller 41 is adjusted to a certain temperature of 100° C., for example.

The above-described pressing roller 41 is press-contacted to the fixing roller 40 with predetermined pressure, such as pressure of 784 N (about 80 kgf), and forms a fixing nip N1 in cooperation with the fixing roller 40. The recording material P is heated and pressed by being nipped and fed at the fixing nip N1. For that reason, the fixing roller 40 is rotated in an arrow R3 direction in the figure and the pressing roller 41 is rotated in an arrow R4 direction in the figure so that the fixing roller 40 and the pressing roller 41 are rotated in the same direction at the fixing nip N2. Further, the pressing roller 41 is movable between a contact (mounted) state in which the pressing roller 41 is press-contacted to the fixing roller 40 and a spaced (demounted) state in which the predetermined roller 41 is spaced from the fixing roller 40, by an unshown a pressing mounting and demounting (contacting and spacing) mechanism. The (contact)/(spaced) state of the pressing roller 41 is discriminated by the controller 50.

### [Cleaning Unit]

Further, the fixing device 9 includes a cleaning unit 60 as a cleaning member for the fixing roller 40. The cleaning unit 60 includes a cleaning web 61 which is a nonwoven fabric, a collecting roller 62 and a web roller 63. The collecting roller 62 is a stainless steel-made cylindrical member formed of 20 mm in diameter, for example. The collecting roller 62 is provided rotatably in a state in which the collecting roller 62 is contacted to the fixing roller 40 over almost an entirety of the fixing roller 40 with respect to the widthwise direction (longitudinal direction, the axial direction), and collects the toner deposited on the fixing roller 40 without being fixed on the recording material P. The collecting roller 62 is always contacted to the fixing roller 40 and is rotated by the fixing roller 40.

The web roller 63 supports the cleaning web 61 and presses (urges) the supported cleaning web 61 against the collecting roller 62 with a force of, e.g., about 40 N. The cleaning web 61 is pressed against the collecting roller 62, and thus wipes off the toner, on the cleaning roller 62, collected from the fixing roller 40. The cleaning web 61 is wound up in one direction (arrow X direction in the figure), and therefore, a fresh surface, of the cleaning web 61, where the toner is not wiped off is always supplied to a contact surface with the collecting roller 62. The web roller 63 is movable between a contact state in which the web roller 63 is press-contacted to the collecting roller 62 and a spaced state in which the web roller 63 is spaced from the collecting roller 62, by an unshown web mounting and demounting (contacting and spacing) mechanism. Incidentally, the collecting roller 62 is press-contacted to the fixing roller 40 with a force (urging) of about 10 N in the spaced state of the web roller 63 and with a force of about 50 N, obtained by adding about 40 N of the web mounting and demounting mechanism to the force of about 10 N, in the contact state of the web roller 63. The mounting/demounting state of the web roller 63 is discriminated by the controller 50.

### [Externally Heating Unit]

In the image forming apparatus, even the recording material, such as temperature difference, having a large basis weight (weight per unit area) is required to provide high productivity (the number of printed sheets per unit time). In order to enhance the productivity for the recording material having the large basis weight, it is desirable that a speed of a heating process in the fixing device 9 is increased. However, the recording material having the large basis weight takes heat in a large amount, and therefore a heat quantity required for fixing becomes large compared with a recording material having a small basis weight. Therefore, as shown in FIG. 2, the fixing device 9 includes an external heating unit 80 as an external heating device, and heats the fixing roller 40 from an outside of the fixing roller 40 by the external heating unit 80 as desired. More specifically, in the case where much heat is transferred from the fixing roller 40 to the recording material P, the external heating unit 80 is provided for quickly replenishing the heat quantity corresponding to an amount of heat delayed in supply by the halogen heater 41a in the pressing roller 41. The external heating unit 80 (specifically an external heating belt 80e heats the fixing roller 40 by contacting the fixing roller 40).

The external heating unit 80 includes the external heating belt 80e, an external heating roller 80a as a first roller for stretching the external heating belt 80e, an external heating roller 80b as a second roller, and halogen heaters 80c and 80d as an external heating means. The external heating belt 80e as a belt member is a belt formed by coating a heat-resistant sliding layer formed of a fluorine-containing resin material (e.g., a PFA tube) on a metal-made base material of stainless steel or the like formed in an endless belt shape, for example. The external heating belts 80a and 80b are formed, similarly as the fixing roller 40 and the pressing roller 41, by coating a heat-resistant sliding layer formed of a fluorine-containing resin material (e.g., a PFA tube) on a metal-made core metal of aluminum or the like formed in a cylindrical shape, for example.

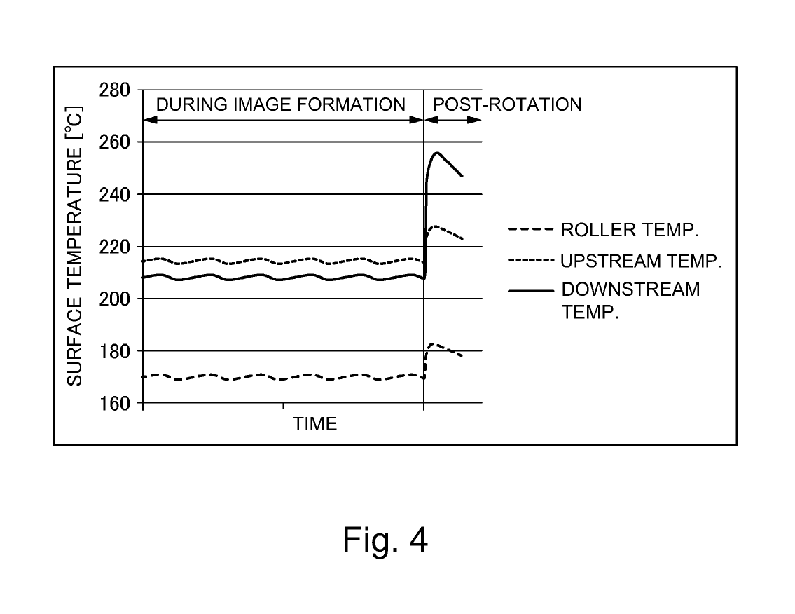

The external heating unit 80 is movable between a contact state in which the external heating unit 80 is press-contacted to the fixing roller 40 by the external heating belt 80e and a spaced state in which the external heating belt 80e is spaced from the fixing roller 40, by a belt mounting and demounting (contacting and spacing) mechanism 57 (see FIG. 4 described later). The contact/spaced state of the external heating unit 80 is discriminated by the controller 50.

In the case where the external heating unit 80 is in the mounted state, the external heating rollers 80a and 80b are press-contacted to the external heating belt 80e toward the fixing roller 40 with predetermined pressure. Then, the external heating belt 80e contacts the surface of the fixing roller 40, and forms an external heating contact portion N2. That is, the external heating belt 80e forms a broad external heating contact portion N2 in cooperation with the fixing roller 40 and is provided for increasing the heat quantity supplied to the fixing roller 40.

The external heating belt 80e and the external heating rollers 80a and 80b are rotated by the fixing roller 40 (arrow R5 direction in the figure). These external heating rollers 80a and 80b are disposed so as to sandwich the external heating contact portion N2 therebetween with respect to a rotational direction of the external heating belt 80e. Further, the external heating rollers 80a and 80b are disposed so that the external heating roller 80a of these rollers is adjacent to an upstream portion of the external heating contact portion N2 and so that the external heating roller 80b of these rollers is adjacent to a downstream portion of the external heating contact portion N2, respectively. That is, the external heating belt 80a is disposed, with respect to the rotational direction (arrow R3 direction in the figure) of the fixing roller 40, in a side upstream of the external heating roller 80b and upstream of the external heating contact portion N2.

Inside the external heating roller 80a, a halogen heater 80c, of, e.g., 1500 W in normal rated power, generating heat by energization is fixedly provided as a first heating means over almost an entirety of the external heating roller 80a. Inside the external heating roller 80b, a halogen heater 80d, of, e.g., 1500 W in normal rated power, generating heat by energization is fixedly provided as a second heating means over almost an entirety of the external heating roller 80b. In this embodiment, to the respective halogen heaters 80c and 80d, electric power which is the same as the normal rated power is supplied. Incidentally, the above-described widthwise direction is also longitudinal directions and rotational axis directions of the external heating rollers 80a and 80b.

Further, the external heating unit 80 includes a toner 81a as a first temperature detecting means and a thermistor 81b as a second temperature detecting means. The thermistor 81a is provided at a position where the thermistor 81a contacts the external heating roller 80a at a portion, of an outer peripheral surface of the external heating belt 80e in an upstream side with respect to the rotational direction of the fixing roller 40, and detects a temperature of the external heating belt 80e in a region in which the external heating roller 80a contacts the external heating belt 80e. The thermistor 81b is provided at a position where the thermistor 81b contacts the external heating roller 80b at a portion, of an outer peripheral surface of the external heating belt 80e in an downstream side with respect to the rotational direction of the fixing roller 40, and detects a temperature of the external heating belt 80e in a region in which the external heating roller 80b contacts the external heating belt 80e.

### [Controller]

The controller 50 (see FIG. 1) subjects the halogen heaters 80a and 80b to ON-OFF control on the basis of temperatures detected by the thermistors 81a and 81b in order to adjust a surface temperature of the external heating belt 80e, and by extension to a surface temperature of the fixing roller 40. However, the controller 50 subjects, during preparation of the image formation, the halogen heater 80c to the ON-OFF control on the basis of the temperature detected by the thermistor 81a and the halogen heater 80d to the ON-OFF control on the basis of the temperature detected by the thermistor 81b respectively. Further, the controller 50 subjects, during image formation, both of the halogen heaters 80c and 80d to the ON-OFF control on the basis of the temperature detected by the temperature 81a.

Here, during image formation is a period from a start of image formation based on a print signal for forming the image on the recording material P to completion of an image forming operation. Specifically, during image formation refers to a period from during pre-rotation after receipt of the print signal (input of an image forming job) to post-rotation (operation after the image formation), and is a period including an image forming period and a sheet interval (during non-image formation). During preparation of the image formation is a state in which a power source of the image forming apparatus 100 is turned on, but the image forming job is not executed. As described above, during image formation is a series of operations including from a pre-rotation operation, the image forming period, the sheet interval and the post-rotation, and therefore during preparation of the image formation refers to a period in which this services of operations is not executed in a state in which the electric power of the image forming apparatus 100 is turned on. Further, during preparation of the image formation includes during stand-by (stand-by state), and during stand-by (stand-by state) is a state in which after the power source of the image forming apparatus 100 is turned on or after the image formation, the image forming apparatus 100 waits for receipt of the print signal in a state in which the series of operations during image formation described above is capable of being performed.

The controller 50 subjects the halogen heaters 80c and 80d to the ON-OFF control, and adjusts the surface temperature of the external heating belt 80e, and by extension to the surface temperature of the fixing roller 40, to a predetermined target temperature. In Table 1, target temperatures (represented as setting temperatures in the table) of the fixing roller 40 and the external heating belt 80e which are used during stand-by and during image formation are shown, respectively. The controller 50 subjects, as described above, the halogen heaters 40a and 41a and the halogen heaters 80c and 80d to the ON-OFF control, and adjusts the surface temperature of the external heating belt 80e, and by extension to the surface temperature of the fixing roller 40, to the target temperatures shown in Table 1. As shown in Table 1, the target temperatures of the fixing roller 40 and the external heating belt 80e are determined depending on the basis weight of the recording material P.

TABLE 1

| Recording material basis weight (g/m²) | | | | | |
|---|---|---|---|---|---|
| 60-79 | 80-99 | 100-149 | 150-199 | 200-249 | 250-350 |

| FRST*¹ | 165 (° C.) | |
|---|---|---|
| TDSB*² | | |
| FRST*¹ | 170 (° C.) | |
| TDIF*³ | | |
| EHBST*⁴ | 190 (° C.) | |
| TDSB⁺² | | |
| EHBST*⁴ | 210 (° C.) | 215 |
| TDIF*³ | | |

*¹“FRST” is the fixing roller setting temperature.
*²“TDSB” is the temperature during stand-by.
*³“TDIF” is the temperature during image formation.
*⁴“EHBST” is the external heating belt setting temperature.

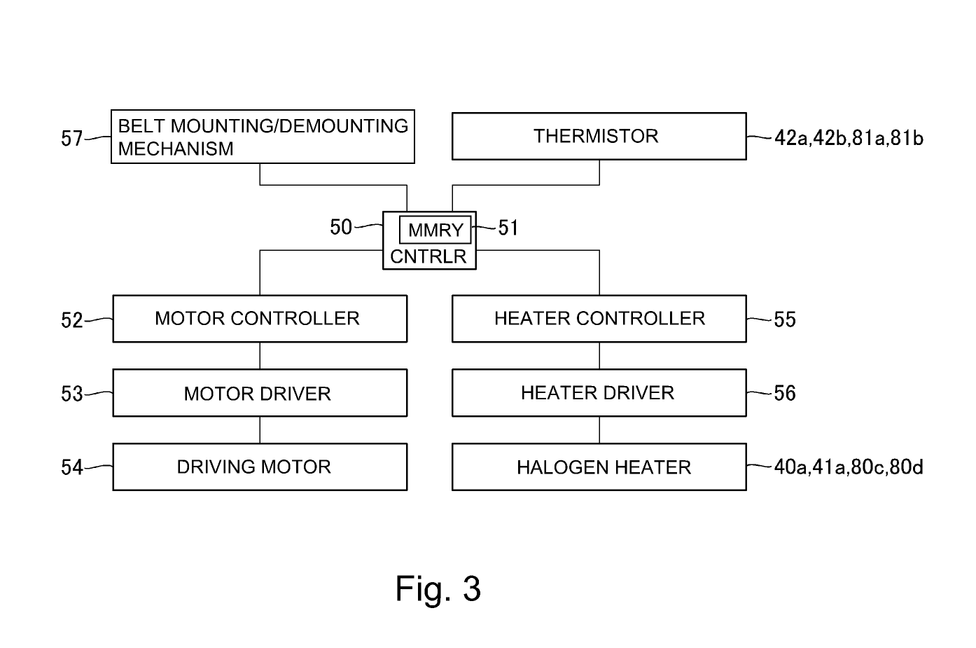

Next, the control of the fixing device 9 will be described using FIGS. 3 to 6. First, FIG. 3 shows a block diagram of a control system of the fixing device 9. The controller 50 is a computer such as a CPU for controlling respective portions of the fixing device 9, and includes a memory 51 as shown in FIG. 3. The memory 51 is ROM, RAM or the like, and stores various programs, data and the like for controlling the image forming apparatus 100. Further, the memory 51 can also temporarily store a calculation process (computation) result with execution of the program. The controller 50 is connected with the operating portion S (see FIG. 1) via an unshown interface, and receives execution start operations of the various programs such as the image forming job by a user or various data inputs by the user, or the like. The controller 50 controls, depending on the execution of the image forming job, the respective portions connected thereto via unshown interfaces and described later, and thus operates the fixing device 9.

To the controller 50, the belt mounting and demounting mechanism 57 is connected. The belt mounting and demounting mechanism 57 moves the external heating unit 80 so as to be movable toward and away from the fixing roller 40. By this, the fixing device 9 is in a state which is either of a contact state in which the fixing roller 40 and the external heating belt 80e are press-contacted to each other or a spaced state in which the fixing roller 40 and the external heating belt 80e are spaced from each other.

The controller 50 individually controls a plurality of driving motors 54 via a motor controller 52 and a motor driver 53. The respective driving motors 54 rotationally drive the fixing roller 40 and the pressing roller 41 in predetermined directions at predetermined speeds, respectively, depending on control by the controller 50. Further, the controller 50 individually subjects the halogen heaters 40a, 41a, 80c and 80d to the ON/OFF control via a heater controller 55 and a heater driver 56. As already described above, depending on control of the halogen heater 40a, the surface temperature of the fixing roller 4 is adjusted, and depending on control of the halogen heater 41a, the surface temperature of the pressing roller 41 is adjusted. Further, depending on the halogen heaters 80c and 80d, the surface temperature of the external heating belt 80e is adjusted.

To the controller 50, the thermistors 42a, 42b, 81a and 81b are connected via unshown interfaces. The controller 50 acquires the surface temperature of the fixing roller 40 (hereinafter, referred to as a fixing roller temperature for convenience) from the thermistor 42a and acquires the surface temperature of the pressing roller 41 from the thermistor 42b. Further, the controller 50 acquires the surface temperature of the external heating belt 80e in an upstream side with respect to a fixing roller rotational direction (hereinafter, referred to as a an external heating upstream temperature for convenience) from the thermistor 81a. Further, the controller 50 acquires the surface temperature of the external heating belt 80e in a downstream side with respect to the fixing roller rotational direction (hereinafter, referred to as an external heating downstream temperature for convenience) from the thermistor 81b. The controller 50 subjects the halogen heaters 40a, 41a, 80c and 80d to the ON-OFF control on the basis of temperatures detected by the temperatures 42a, 42b, 81a and 81b, and thus carries out control of adjusting the surface temperature of the fixing roller 40 to a predetermined target temperature.

Here, in FIG. 4, in the case where image formation is carried out on a large number of sheets of thick paper (basis weight: 250 g/m² as an example) by using a fixing device in a comparison example, time progressions of the fixing roller temperatures, the external heating upstream temperatures and the external heating downstream temperatures detected by the thermistors 42a, 81a and 81b are shown. In the fixing device in the comparison example, with regard to the external heating unit 80, the control of the halogen heater 80c is carried out on the basis of the temperature detected by the thermistor 81a, and the control of the halogen heater 80d is carried out on the basis of the temperature detected by the thermistor 81b. In FIG. 4, the ordinate represents the surface temperature, and the abscissa represents the time. In this case, a target temperature Trp of the fixing roller temperature used during image formation is 170° C., and a target temperature Tex1p (first target temperature) of the external heating upstream temperature and a target temperature Tex2p (second target temperature) of the external heating downstream temperature which are used during image formation are 215° C. (see Table 1). Incidentally, a target temperature of the surface temperature of the pressing roller 41 is always 100° C.

As shown in FIG. 4, during image formation, the fixing roller temperature and the external heating upstream temperature reach 170° C. and 215° C., respectively, which are the target temperatures thereof. The fixing roller temperature and the external heating upstream temperature during image formation change while somewhat fluctuating, but this shows that the respective surface temperatures are can fluctuate with predetermined temperature ripples depending on the ON/OFF control of the halogen heaters 40a and 80c.

On the other hand, during image formation, the external heating downstream temperature changes at the target temperature or less without reaching 215° C. which is the target temperature. This is because heat supply is carried out at the external heating contact portion N2, and thus the surface temperature in the downstream side, with respect to the fixing roller rotational direction, immediately after passing through the external heating contact portion N2 is lower than the surface temperature in the upstream side, with respect to the fixing roller rotational direction, in front of the external heating contact portion N2. That is, when the external heating upstream temperature reaches the target temperature of 215° C., the halogen heater 80c is turned off, and therefore, a heat quantity supplied from the external heating belt 80e to the fixing roller 40 decreases. As a result, the heat quantity supplied from the external heating belt 80e to the fixing roller 40 becomes larger than a total heat quantity received by the external heating belt 80e from the external heating rollers 80a and 80b, and therefore the external heating downstream temperature does not reach 215° C. The external heating downstream temperature does not reach 215° C., and therefore the halogen heater 80d is not turned off and continues a turned-on state. Incidentally, also the external heating downstream temperature changes while somewhat fluctuating, but this shows a thermal fluctuation depending on heat transfer from the fixing roller 40 to the recording material P.

When the turned-on state of the halogen heater 80d is continued, after image formation, particularly the temperature of the external heating roller 80b abruptly increases, so that the external heating downstream temperature can overshoot largely toward a high-temperature side. Every execution of the image forming job, when a state in which the external heating downstream temperature overshoots and becomes a high temperature is repeated, there is a large liability that due to thermal deterioration, not only the fixing roller 40 and the external heating roller 80b but also the external heating belt 80e are broken.

As one of methods for solving this problem, it would be considered that during image formation, the external heating upstream temperature and the external heating downstream temperature are set at different temperatures, specifically the external heating downstream temperature is set at a lower temperature than the external heating upstream temperature. However, a temperature difference between t external heating upstream temperature and the external heating downstream temperature varies depending on the type of paper (sheet) and the paper (sheet) interval, so that the above-described method cannot meet various sheet types and sheet intervals, and therefore it is difficult to employ the method.

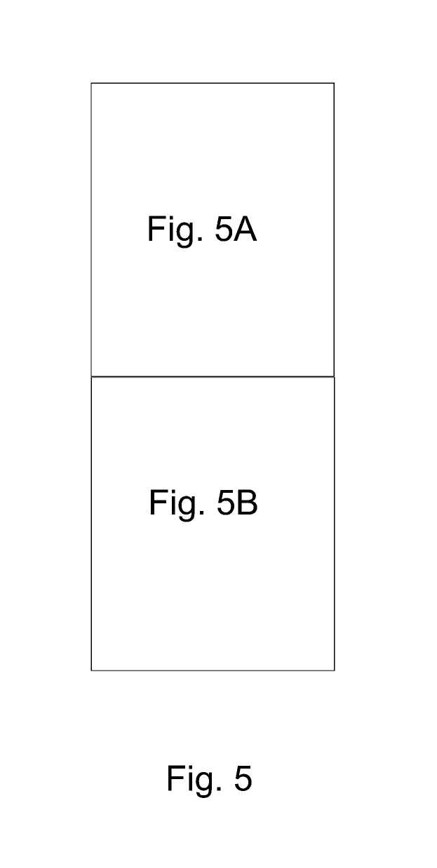

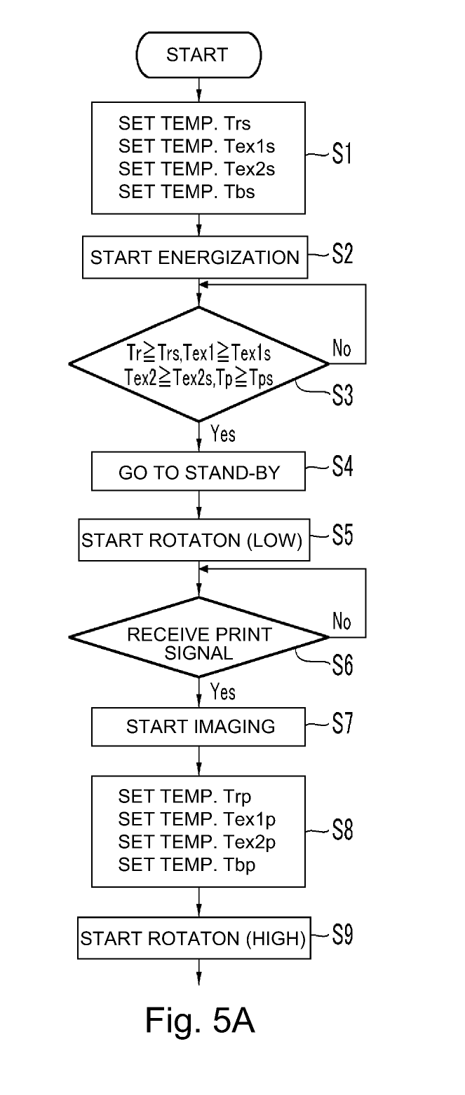

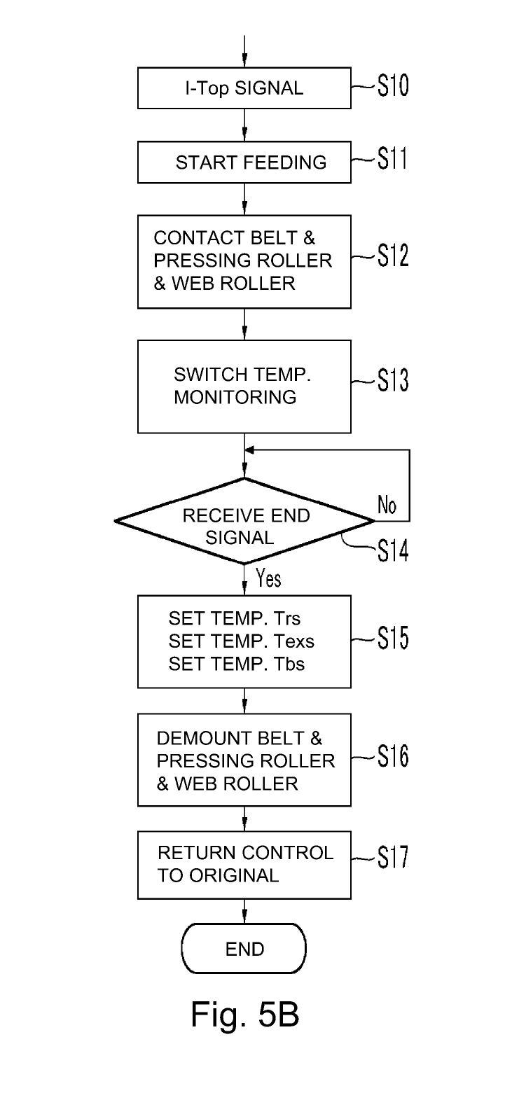

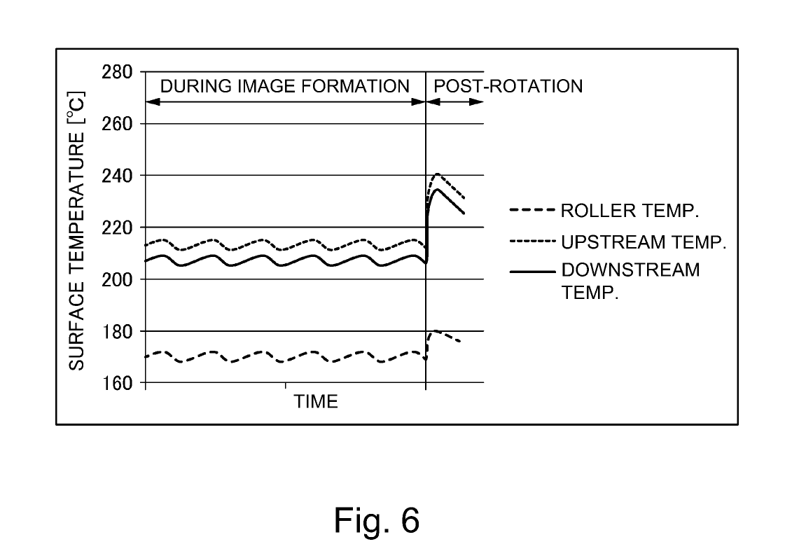

Therefore, in the image forming apparatus 100, during image formation, both of the halogen heaters 80c and 80d were simultaneously subjected to the ON/OFF control on the basis of only the temperature detected by the thermistor 81a. In the following, description will be made using FIGS. 5 and 6 while appropriately making reference to FIGS. 2 and 3. FIG. 5 (5A, 5B) is a flowchart showing control (mode) of the fixing device. This control of the fixing device is started in synchronism with the tuning-on of the power source of the apparatus main assembly by the controller 50, and is ended in synchronism with an end of the image forming job. Incidentally, here, the case where the user sets the thick paper of 250 g/m² in basis weight as the sheet type and an image forming job for carrying out continuous image formation on a large number of sheets of the thick paper is taken as an example and will be described.

As shown in FIG. 5, the controller 50 set a target temperature Trs of the fixing roller temperature, a target temperature Tex1s of the external heating upstream temperature, a target temperature Tex2s of the external heating downstream temperature and a target temperature Tbs, of the surface temperature of the pressing roller 41, which are to be used during stand-by (S1). From the above-described Table 1, the target temperature Trs of the fixing roller temperature used during stand-by is set at 165° C., and the target temperature Tex1s of the external heating upstream temperature and the target temperature Tex2s of the external heating downstream temperature which are used during stand-by are set at 190° C. Further, the target temperature Tbs of the surface temperature of the pressing roller 41 is set at 100° C.

The controller 50 starts energization to the respective halogen heaters 40a, 41a, 80c and 80d of the fixing device 9 (S2). That is, the controller 50 carries out control for energizing (turning on) the halogen heaters 40a, 41a, 80c and 80d via the heater controller 55 and the heater driver 56. The controller 50 discriminates, after the above-described energization, whether or not the surface temperature of the fixing roller 40, the external heating upstream temperature and the external heating downstream temperature of the external heating belt 80e, and the surface temperature of the pressing roller 41 reach the target temperatures Trs, Tex1s, Tex2s and Tbs, respectively (S3). This discrimination is carried out on the basis of comparison with temperatures detected by the respective thermistors 42a, 81a, 81b and 42. The controller 50 repeats the process of S3 until the above-described respective surface temperatures reach the target temperatures Trs, Tex1s, Tex2s and Tbs, and stand by (NO of S3). That is, the controller 50 controls the energization to the halogen heater 80c so that the detection temperature by the thermistor 81a is the target temperature Tex1s (first target temperature). Further, the controller 50 controls the energization to the halogen heater 80d so that the detection temperature by the thermistor 81b is the target temperature Tex2s (second target temperature). Thus, during preparation of the image formation, pre-heating of the fixing roller 40 is carried out.

In the case where the above-described respective temperatures reach the target temperatures Trs, Tex1s, Tex2s and Tbs, respectively (YES of S3), the controller 50 causes the fixing device 9 to go to the stand-by state (S4), and causes the fixing roller 40 to start rotation at a speed lower than a speed during image formation (S5). The controller 50 controls the driving motor 54 via the motor controller 52 and the motor driver 53 and causes the fixing roller 40 to rotate at a speed which is half of a predetermined speed (e.g., 500 mm/sec) during image formation, for example. Further, in the case where the fixing device 9 is in during stand-by (stand-by state), the controller 50 subjects the respective halogen heaters to the ON/OFF control so as to maintain the target temperatures Trs, Tex1s, Tex2s and Tbs, and thus effect temperature adjustment.

The controller 50 discriminates whether or not the print signal is received (S6). The controller 50 repeats the process of S6 until the print signal is received and stands by (NO of S6). In the case where the print signal is received (YES of S6), the controller 50 starts image formation (S7). Then, the controller 50 changes the respective target temperatures to a target temperature Trp of the fixing roller temperature, a target temperature Tex1p of the external heating upstream temperature, a target temperature Tex2p of the external heating downstream temperature and a target temperature Tbp of the surface temperature of the pressing roller 41, which are to be used during image formation (S8). From the above-described Table 1, the target temperature Trp of the fixing roller temperature used during image formation is changed to 170° C., and the target temperature Tex1p of the external heating upstream temperature and the target temperature Tex2p of the external heating downstream temperature which are used during image formation are changed to 215° C. Incidentally, the target temperature Tbp of the surface temperature of the pressing roller 41 is 100° C. as it is.

The controller 50 causes the fixing roller 40 to be rotationally driven so that the speed increases up to the predetermined speed (e.g., 500 mm/sec) during image formation (S9). Further, the controller 50 starts feeding of the recording material P, depending on receipt of an image writing signal (hereinafter, referred to as an I-Top signal (S10), by using a receiving time of an I-Top signal as a reference time (S11). At this time, the feeding of the recording material P may be started irrespective of whether or not the fixing roller temperature, the external heating upstream temperature, the external heating downstream temperature and the surface temperature of the pressing roller 41 reach the target temperatures changed in the above-described S8. This is for the following reason. That is, when the surface temperatures reach the target temperatures, the halogen heaters are turned off, and thereafter the recording material P reaches the fixing nip N1 in some instances. In that case, core metal temperatures of the respective rollers lower, and therefore particularly when the recording materials P are continuously fed, the fixing roller temperature can be below a predetermined temperature necessary to fix the toner (image) on the recording material P, i.e., the target temperature. The above is because improper toner fixing on the recording material P due to such a temperature lowering of the fixing roller temperature is avoided.

When the sheet feeding is started, the controller 50 causes the external heating belt 80e, the pressing roller 41 and the web roller 63 to be pressed against and contacted to the fixing roller 40 on the basis of the receiving time of the I-Top signal before the recording material P reaches the fixing nip N1 (S12). That is, the external heating belt 80e, the pressing roller 41 and the web roller 63 are moved to a state in which the respective members are contacted to the fixing roller, i.e., a contact state by the belt mounting and demounting mechanism, the pressing mounting and demounting mechanism and the web mounting and demounting mechanism.

Then, the controller 50 changes the temperature control of the external heating belt 80e so as to be carried out on the basis of only the temperature detected by the thermistor 81a for detecting the external heating upstream temperature (S13). That is, when detection that the external heating belt 80e is in the contact state is made, the controller 50 switches, on the basis of the temperature detected by the thermistor 81a, both of the halogen heaters 80c and 80d simultaneously so as to be subjected to the ON-OFF control. More specifically, the halogen heater 80d in the downstream side with respect to the rotational direction of the fixing roller 40 is switched, on the basis of the detection temperature of the thermistor 81a in the upstream side with respect to the rotational direction of the fixing roller 40, simultaneously with the halogen heater 80c so as to be subjected to the ON-OFF control. In this case, the controller 50 controls the energization to the halogen heater 80d simultaneously with control of the energization to the halogen heater 80c so that the detection temperature by the thermistor 81a is the target temperature Tex1s. Incidentally, even in the case where the temperature control of the external heating belt 80e is switched to control based on only the thermistor 81a as described above, the controller 50 monitors, on the basis of the temperature detected by the thermistor 81b, whether or not there is no abnormality in external heating downstream temperature. In the case where there is an abnormality in external heating downstream temperature, the controller 50 causes the display portion of the operating portion S to display an error and notifies the user of the abnormality, for example.

The controller 50 discriminates whether or not an image formation end signal is received (S14). In the case where the image formation end signal is received (YES of S14), the controller 50 changes the respective target temperatures to the target temperatures Trs, Tex1s, Tex2s and Tbs during stand-by (S15). Then, the controller 50 causes the external heating unit 80, the pressing roller 41 and the web roller 63 to be spaced from the fixing roller 40 and be placed in the spaced state, by the belt mounting and demounting mechanism, the pressing mounting and demounting mechanism and the web mounting and demounting mechanism (S16). That is, the controller 50 causes the fixing device 9 to go to the stand-by state. In the case of the stand-by state, these members are kept in the contact state, deformation and distortion of the elastic layers at the fixing nip N1 and the external heating contact portion N2 remain, so that lateral stripes, glossy stripes (uneven glossiness) and the like generate and thus an image quality can lower. In order to avoid this, in the stand-by state, the external heating unit 80, the pressing roller 41 and the web roller 63 are spaced from the fixing roller 40.

When the controller 50 causes the fixing device 9 to go to the stand-by state, the controller 50 returns the temperature control of the external heating belt 80e only by the thermistor 81a changed in the above-described S13 to that before the change (S17). That is, when the controller 50 detects that the external heating belt 80e is in the spaced state, the controller 50 returns the temperature control of the external heating belt 80e to the original temperature control. That is, the controller 50 returns the temperature control of the external heating belt 80e so that the temperature control is not effected on the basis of only the temperature detected by the thermistor 81a for detecting the external heating upstream temperature but is effected on the basis of the temperatures detected by the thermistors 81a and 81b. Thus, in the case where the external heating belt 80e is in the spaced state, the control of the halogen heater 80c is carried out on the basis of the temperature detected by the thermistor 81a and the control of the halogen heater 80d is carried out on the basis of the temperature detected by the thermistor 81b.

In FIG. 6, in the case where image formation is carried out on a large number of sheets of thick paper (basis weight: 250 g/m² as an example) by using a fixing device in this embodiment, time progressions of the fixing roller temperatures, the external heating upstream temperatures and the external heating downstream temperatures detected by the thermistors 42a, 81a and 81b are shown. In FIG. 6, the ordinate represents the surface temperature, and the abscissa represents the time.

As can be understood by comparing FIG. 6 with FIG. 4 described above, also in the fixing device 9 in this embodiment, during image formation, the fixing roller temperature and the external heating upstream temperature reach 170° C. and 215° C., respectively, which are the target temperatures thereof. Further, during image formation, the fixing roller temperature and the external heating upstream temperature change while somewhat fluctuating, with predetermined temperature ripples depending on the ON/OFF control of the halogen heaters 40a and 80c. On the other hand, the external heating downstream temperature changes depending on the ON-OFF control of the halogen heater 80d, at the target temperature or less without reaching 215° C. which is the target temperature. Further, it is understood that during post-rotation, an increase in surface temperature of the external heating roller 80b by overshooting can be suppressed.

As described above, during image formation, the halogen heater 80d in the downstream side with respect to the rotational direction of the fixing roller 40 is ON-OFF controlled, on the basis of the detection temperature of the thermistor 81a in the upstream side with respect to the rotational direction of the fixing roller 40, simultaneously with the halogen heater 80c. That is, during image formation, the ON/OFF control of the halogen heater 80d is not carried out on the basis of the surface temperature, lower than the belt surface temperature in the upstream side with respect to the rotational direction of the fixing roller 40, of the external heating belt 80e after passing through the external heating contact portion N2. By doing so, localization of electric power supply to each of the two external heating rollers 80a and 80b does not generate, so that these rollers are similarly heated. For this reason, when the external heating belt 80e is stopped after image formation, the surface temperature of the external heating roller 80b is prevented from abruptly increasing. That is, particularly, it is possible to suppress the increase in surface temperature of the external heating roller 80b by the overshooting. By this, a liability that not only the fixing roller 40 and the external heating roller 80b but also the external heating belt 80e are broken due to thermal deterioration can be reduced. Further, it is possible to lower a possibility that image defects such as fixing non-uniformity, uneven glossiness and color unevenness.

### Second Embodiment

Incidentally, the user erroneously sets the recording material P with a basis weight larger than a set basis weight and executes the image forming job in some instances. For example, such a case that plain paper of 81 g/m² in basis weight and thick paper of 240 g/m² in basis weight exist in mixture although the plain paper of 81 g/m² in basis weight is set as the recording material P exists. In this case, the thick paper of 240 g/m² in basis weight is fed substantially to the plain paper of 81 g/m² in basis weight, and therefore, image formation on the thick paper is carried out subsequently to the plain paper. When the recording material P changes from the plain paper to the thick paper, the quantity of the heat transferred from the fixing roller 40 to the recording material P increases. For that reason, supply of the heat from the external heating unit 80 to the fixing roller 40 cannot catch up with the transfer of the quantity of the heat, with the result that the image formation on the thick paper is carried out while the surface temperature of the fixing roller 40 is lower than the target temperature necessary for the fixing. In the following, this point will be described.

First, in Table 2, a lowest (point) temperature in the case where although the plain paper of 81 g/m² in basis weight is set as the recording material P, the recording material P with a basis weight of 81 g/m² or more is fed during image formation and the surface temperature of the fixing roller 40 is lowest is shown for each of basis weights of the recording materials P.

TABLE 2

| | Recording material basis weight (g/m²) | | | | |
|---|---|---|---|---|---|
| | 81 | 100 | 150 | 200 | 240 |
| FRLT*¹ | 167 | 165 | 160 | 155 | 150 |

*¹“FRLT” is the fixing roller lowest temperature.

In the case where the plain paper of 81 g/m² in basis weight which is the same as user setting is fed, the respective halogen heaters 80c and 80d are individually controlled so that the external heating upstream temperature and the external heating downstream temperature detected by the thermistors 81a and 81b are 210° C. (see Table 1). However, with image formation on a large number of sheets of the recording material P, the external heating downstream temperature detected by the thermistor 81b gradually lowers and is maintained at 208° C., for example. This is due to supply of the heat from the external heating belt 80e to the fixing roller 40 at the external heating contact portion (nip). Further, with an increasing basis weight, heat transferred from the fixing roller 40 to the recording material P is larger, and therefore, as shown in Table 2, with a larger basis weight of the fed recording material P than the basis weight set by the user, the external heating downstream temperature detected by the thermistor 81b becomes lower.

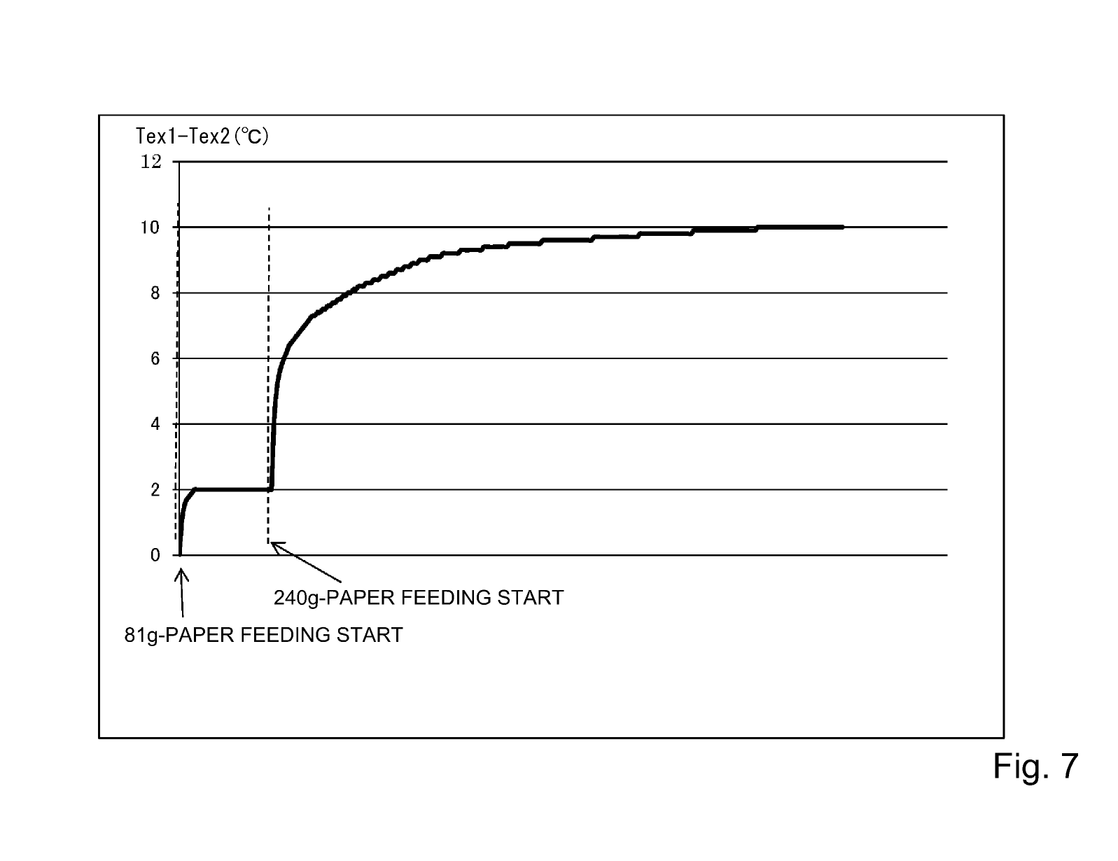

FIG. 7 is a graph showing a temperature difference (Tex1−Tex2) between a detection temperature Tex1 of the thermistor 81a and a detection temperature Tex2 of the thermistor 81b in the case where the thick paper of 240 g/m² in basis weight is fed subsequently to the plain paper of 81 g/m² in basis weight and the image formation is carried out.

As shown in FIG. 7, when the recording material P with the basis weight of 81 g/m² is fed and the image formation is started, the temperature difference (Tex1−Tex2) gradually extends from a state of 0° C. and is maintained at 2° C. This fixing device generates with supply of the heat from the external heating belt 80e to the fixing roller 40 lowering in temperature by heat transfer to the recording material P, and therefore, is unchanged and stabilized in the case where the recording materials P with the same basis weight are continuously fed. However, when the recording material P with the basis weight of 240 g/m² is fed, the fixing roller temperature further lowers, to that the heat supplied from the external heating belt 80e to the recording material P increases. Then, the temperature of the detection temperature Tex2 of the thermistor 81b lowers compared with the case of the recording material P with the basis weight of 81 g/m², and therefore, the temperature difference with the detection temperature Tex1 of the thermistor 81a extends to 10° C.

In Table 3, an upper-limit temperature (allowable upper-limit temperature) and a lower-limit temperature (fixable temperature) of the surface temperature, of the fixing roller 40, appropriate for the toner fixing on the recording material P are shown for each of basis weights of the recording materials P.

TABLE 3

| | Recording material basis weight (g/m²) | | | | | |
|---|---|---|---|---|---|---|
| | 60-79 | 80-99 | 100-149 | 150-179 | 180-199 | 200-249 |
| AULT*¹ (° C.) | 175 | 180 | 185 | 190 | 195 | 200 |
| FT*² | 135 | 140 | 147 | 153 | 155 | 157 |

*¹“AULT” is the allowable upper-limit temperature.
*²“FT” is the fixable temperature.

As described above, for example, when the recording material P with a large basis weight is fed in the case where the user setting is the basis weight of 81 g/m², the surface temperature of the fixing roller 40 is below the fixable temperature necessary for the toner fixing. That is, when the recording material P with the basis weight of 240 g/m² is fed in the case where the user setting is the basis weight of 81 g/m², the lowest temperature of the fixing roller 40 is 150° C. (see Table 2) and is below the fixable temperature of 157° C. (see Table 3) at the time of the recording material P with the basis weight of 240 g/m².

However, when the surface temperature of the fixing roller 40 is kept at a low temperature which is below the fixable temperature, the toner image is not fixed, and a phenomenon which is called a cold offset such that the toner is deposited on the fixing roller 40 generates, so that this can cause generation of the image defect. Further, when the toner deposited on the fixing roller 40 is deposited on a subsequent recording material P, image contamination occurs. Further, in the case where the user continues (image formation without noting the generation of the cold offset, the toner can be deposited on, in addition to the fixing roller 40, the cleaning unit 60 and the external heating belt 80e and the like. In such a state, when the operation of the fixing device 9 is stopped and the fixing device 9, specifically the fixing device 40, the cleaning unit 60, the external heating belt 80e and the like are cooled, the toners deposited on these members stick thereto. When the toners stick thereto, there is a large liability that the fixing roller 40, the cleaning unit 60, the external heating belt 80e and the like are damaged when the fixing device 9 is operated again. Therefore, in the case such that the recording material P different in various pieces of information (for example, the basis weight) from the recording material P set by the user is fed during image formation, there is a need to increase the surface temperature of the fixing roller 40 up to a temperature exceeding at least the fixable temperature. However, as in the above-described First Embodiment, in the case where the surface temperature of the external heating belt 80e is controlled only by the thermistor 81a during image formation, it becomes difficult to increase the surface temperature of the fixing roller 40 up to the temperature exceeding the fixable temperature.

Therefore, in the following, a fixing device according to Second Embodiment in which the above-described problem is solved will be described. However, a constitution and a control system of the fixing device 9 according to Second Embodiment are similar to those in the above-described First Embodiment (see FIGS. 2 and 3), and therefore will be omitted from description.

Here, in Table 4, respective target temperatures (represented as setting temperatures in the table) of the fixing roller 40 and the external heating belt 80e which are used during stand-by and during image formation are shown. The controller 50 subjects, as described above, the halogen heaters 40a and 41a and the halogen heaters 80c and 80d to the ON-OFF control, and adjusts the surface temperature of the external heating belt 80e, and by extension to the surface temperature of the fixing roller 40, to the target temperatures shown in Table 4. As can be understood from Table 4, the target temperatures of the fixing roller 40 and the external heating belt 80e are determined depending on the basis weight of the recording material P. Further, a turning-on duty (turning-on ratio) of the external (heating) heater, i.e., the halogen heaters 80c and 80d is different for each of basis weights of the recording materials P. Incidentally, in the fixing device according to Second Embodiment, the controller 50 effects control for energizing the halogen heaters 80c and 80d in accordance with the turning-on duty.

TABLE 4

| | Recording material basis weight (g/m²) | | | | | |
|---|---|---|---|---|---|---|
| | 60-79 | 80-99 | 100-149 | 150-179 | 180-199 | 200-249 |
| FRST*¹ | 165 (° C.) | | | | | |
| TDSB*² | | | | | | |
| FRST*¹ | 170 (° C.) | | | | | |
| TDIF*³ | | | | | | |
| EHBST*⁴ | 190 (° C.) | | | | | |
| TDSB⁺² | | | | | | |
| EHBST*⁴ | 210 (° C.) | | | | | |
| TDIF*³ | | | | | | |
| EHTOD*⁵ | 40 | 40 | 80 | 80 | 90 | 100 |
| (%) | | | | | | |

*¹“FRST” is the fixing roller setting temperature.
*²“TDSB” is the temperature during stand-by.
*³“TDIF” is the temperature during image formation.
*⁴“EHBST” is the external heating belt setting temperature.
*⁵“EHTOD” is the external heater turning-on duty.

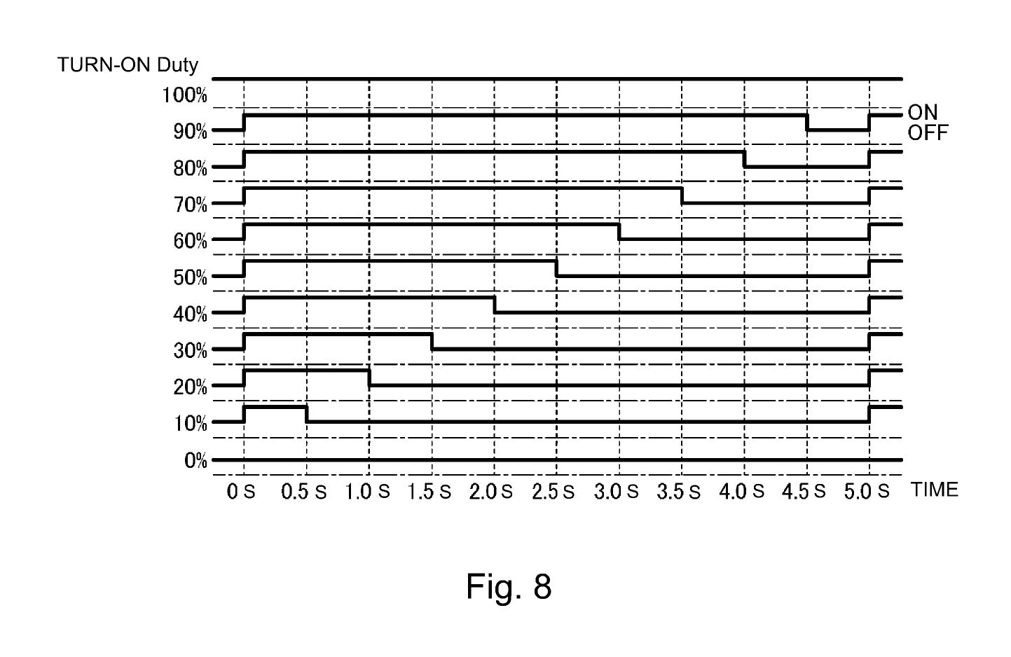

The above-described “turning-on duty” represents a proportion of a time, in which the halogen heaters 80c and 80d are energized in actuality, of a predetermined time in the case where energization to the halogen heaters 80c and 80d for a predetermined time (for 5 seconds, for example). In FIG. 8, a relationship of the turning-on duty with an energization time and a non-energization time of the halogen heaters 80c and 80d was shown. In FIG. 8, the ordinate represents the turning-on duty (%), and the abscissa represents the time (seconds). As shown in FIG. 8, for example, in the case where the turning-on duty is 60%, it is shown that of 5 seconds, for the first 3 seconds, the energization is made (ON), and for the remaining 2 seconds, the energization is not made (OFF, non-energization).

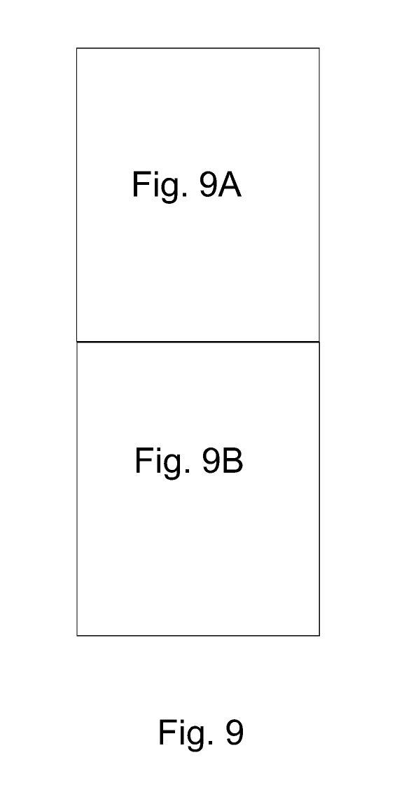

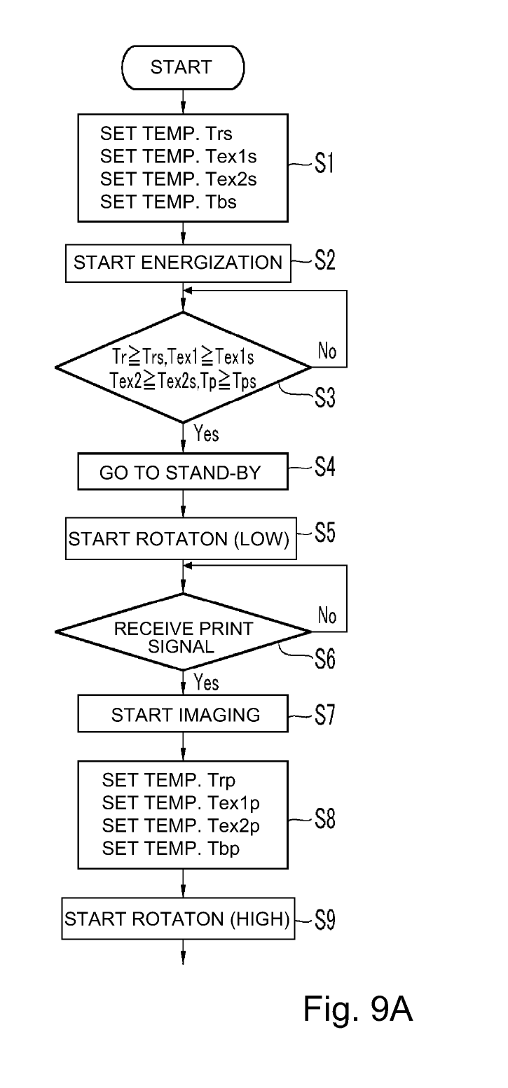

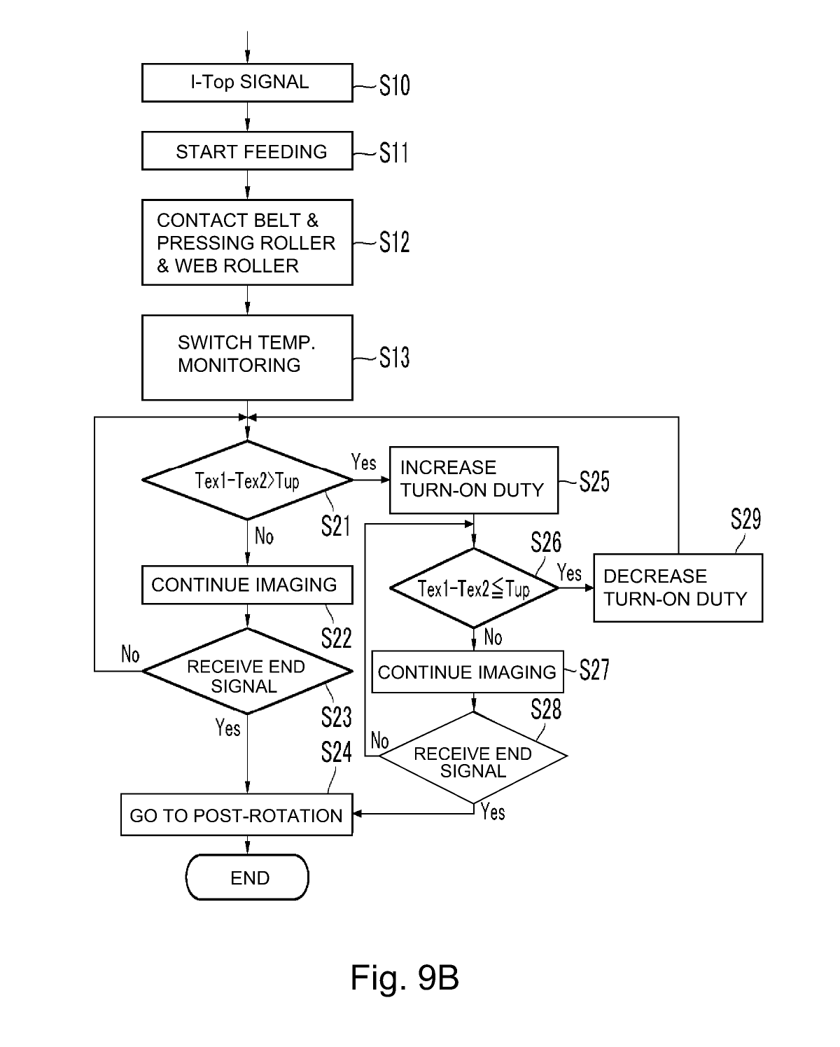

FIG. 9 is a flowchart showing the control of the fixing device in Second Embodiment. However, a portion overlapping in description with the control shown in the above-described FIG. 5 will be omitted from explanation. Further, description will be made by taking, as an example, the case where the thick paper with the basis weight of 240 g/m² was fed during image formation although the plain paper with the basis weight of 81 g/m² is set as the recording material P.

As shown in FIG. 9 (9A, 9B), the controller 50 starts, after a process of S1 is executed, energization to the respective halogen heaters 40a, 41a, 80c and 80d of the fixing device (S2). However, the turning-on duty of the halogen heaters 80c and 80d in this case is 100% irrespective of the basis weight set by the user. That is, the halogen heaters 80c and 80d are always energized. Thereafter, the controller 50 executes respective processes of S3 to S7.

The controller 50 changes the respective target temperatures to a target temperature Trp of the fixing roller temperature, a target temperature Tex1p of the external heating upstream temperature, a target temperature Tex2p of the external heating downstream temperature and a target temperature Tbp of the surface temperature of the pressing roller 41, which are to be used during image formation (S8). From the above-described Table 4, the target temperature Trp of the fixing roller temperature used during image formation is changed to 170° C., and the target temperature Tex1p of the external heating upstream temperature and the target temperature Tex2p of the external heating downstream temperature which are used during image formation are changed to 210° C. The target temperature Tbp of the surface temperature of the pressing roller 41 is 100° C. At this time, the turning-on duty is changed to 40% in accordance with the setting for the basis weight of 81 g/m², and the halogen heaters 80c and 80d are energized. That is, the halogen heaters are repetitively energized for 2 seconds with an interval of 3 seconds.

After execution of the respective processes S9 to S12, the controller 50 changes the temperature control of the external heating belt 80e so as to be carried out on the basis of only the temperature detected by the thermistor 81a for detecting the external heating upstream temperature (S13). That is, when the contact state of the external heating belt 80e is detected, the controller 50 causes, on the basis of the temperature detected by the thermistor 81a, both of the halogen heaters 80c and 80d simultaneously so as to be subjected to the ON-OFF controllable. However, in this Second Embodiment, even when the halogen heaters 80c and 80d are simultaneously subjected to the ON control, these heaters 80c and 80d are repetitively subjected to the energization (ON) and the non-energization (OFF) with a predetermined time interval in accordance with the turning-on duty. Thus, the overshooting of the surface temperature of external heating belt 80e after the image formation is suppressed.

The controller 50 discriminates whether or not the temperature difference (Tex1−Tex2) between the detection temperature Tex1 of the thermistor 81a and the detection temperature Tex2 of the thermistor 81b is larger than a temperature difference Tup (4° C., for example) as a first predetermined value (S21). In the case where the temperature difference (Tex1−Tex2) is not more than the first predetermined value, i.e., not more than the predetermined temperature difference Tup (NO of S21), the controller 50 continues image formation without changing the turning-on duty of the halogen heaters 80c and 80d from 40% (S22). That is, in this case, the temperature of the detection temperature Tex2 of the thermistor 81b does not largely lower, so that the temperature difference with the detection temperature Tex1 of the thermistor 81a is small. For that reason, there is a small liability that the surface temperature of the fixing roller 40 becomes a low temperature which is below the fixable temperature, so that there is no need to carry out control of increasing the external heating downstream temperature in order to increase the surface temperature of the fixing roller 40, i.e., control of increasing the turning-on duty of the halogen heater 80d.

The controller 50 discriminates whether or not a print end signal is received (S23), and in the case where the print end signal is not received (NO of S23), the process is returned to the process of the above-described S21. In the case where the print end signal is received (YES of S23), a post-rotation operation is performed (S24), and the process is ended. In the post-rotation operation in this embodiment, the controller 50 executes the above-described process S15 to S17 of FIG. 5. That is, the controller 50 changes the respective target temperatures to the target temperatures Trs, Tex1s, Tex2s and Tbs during stand-by (S15). Then, the controller 50 causes the external heating unit 80, the pressing roller 41 and the web roller 63 to be spaced from the fixing roller 40 and be placed in the spaced state (S16). The controller 50 returns the temperature control of the external heating belt 80e only by the thermistor 81a to the temperature control before the change (S17).

On the other hand, in the case where the temperature difference (Tex1−Tex2) is larger than the predetermined temperature difference Tup (YES of S21), the controller 50 increases the turning-on duty of the halogen heater 80d of those of the halogen heaters 80c and 80d (S25). For example, the controller 50 increases the turning-on duty, which was 40%, up to 100%. That is, in this case, the temperature of the detection temperature Tex2 of the thermistor 81b largely lowers, so that the temperature difference with the detection temperature Tex1 of the thermistor 81a becomes large. For that reason, there is a liability that the surface temperature of the fixing roller 40 becomes a low temperature which is below the fixable temperature. Therefore, in order to increase the surface temperature of the fixing roller 40, control of increasing the external heating downstream temperature, i.e., control of increasing the turning-on duty of the halogen heater 80d is effected.

The controller 50 discriminates whether or not the temperature difference (Tex1−Tex2) is not more than the predetermined temperature difference Tup after the process of S25 (S26). In the case where the temperature difference (Tex1−Tex2) is larger than the predetermined temperature difference Tup (NO of S26), the controller 50 continues the image formation without returning the turning-on duty of the halogen heater 80d from 100%, after the change, to the original value (S27). That is, in a period in which the temperature difference (Tex1−Tex2) is larger than the predetermined temperature difference Tup, there is a liability that the surface temperature of the fixing roller 40 becomes low temperature which is below the fixable temperature, and therefore, there is a need to subsequently increase the external heating downstream temperature. For that reason, the halogen heater 80d is energized in accordance with the increased turning-on duty after the change.

The controller 50 discriminates whether or not a print end signal is received (S28), and in the case where the print end signal is not received (NO of S28), the process is returned to the process of the above-described S26. In the case where the print end signal is received (YES of S28), a post-rotation operation is performed (S24), and the process is ended. In the post-rotation operation in this embodiment, the controller 50 executes the process S15 to S17 of FIG. 5 as described above.

In the above-described process of S26, in the case where the temperature difference (Tex1−Tex2) is not more than the predetermined temperature difference Tup (YES of S26), the controller 50 returns the turning-on duty of the halogen heater 80d to the turning-on duty before the change (S29). For example, the controller 50 decreases the turning-on duty, which was 100%, to 40%. That is, control of increasing the turning-on duty of the halogen heater 80d (see S25), and therefore, the external heating downstream temperature increases, so that the surface temperature of the fixing roller 40 becomes a temperature exceeding the fixable temperature. However, when the surface temperature of the fixing roller 40 is further increased, the fixing roller 40 or the like can be broken. Therefore, the turning-on duty of the halogen heater 80d is decreased and returned to the original value, whereby a further increase in surface temperature of the fixing roller 40 is suppressed. After the process of S29, the process is returned to the above-described process of S21, and the controller 50 repeats the processes of S21 to S29.

As described above, also in Second Embodiment, during image formation, the halogen heater 80d in the downstream side with respect to the rotational direction of the fixing roller 40 is ON-OFF controlled, on the basis of the detection temperature of the thermistor 81a in the upstream side with respect to the rotational direction of the fixing roller 40, simultaneously with the halogen heater 80c. Then, on the basis of a difference in detection temperature between the two thermistors 81a and 81b, control of increasing the turning-on duty of the halogen heater 80d is carried out in the case where the heat quantity supplied from the external heating belt 80e to the fixing roller 40 is insufficient. By this, during image formation, the recording material P is changed from the plain paper to the thick paper, for example, and even when the quantity of the heat transferred from the fixing roller 40 to the recording material P is increased, it is possible to carry out sufficient heat supply from the external heating unit 80 to the fixing roller 40. For that reason, the image formation on the thick paper is not effected while making the surface temperature of the fixing roller 40 lower than a necessary target temperature. Accordingly, the image defect due to the generation of the cold offset is not readily generated.

Incidentally, in Second Embodiment, in the case where the temperature difference (Tex1−Tex2) is larger than the predetermined temperature difference Tup, the turning-on duty of only the halogen heater 80d is changed (see S25), but the present invention is not limited thereto, and the turning-on duty of both of the halogen heaters 80c and 80d may also be changed. In that case, in the above-described process of S26, when the temperature difference (Tex1−Tex2) is not more than the predetermined temperature difference Tup, the turning-on duty of the both of the halogen heaters 80c and 80d is returned to the turning-on duty before the change (S29).

### Third Embodiment

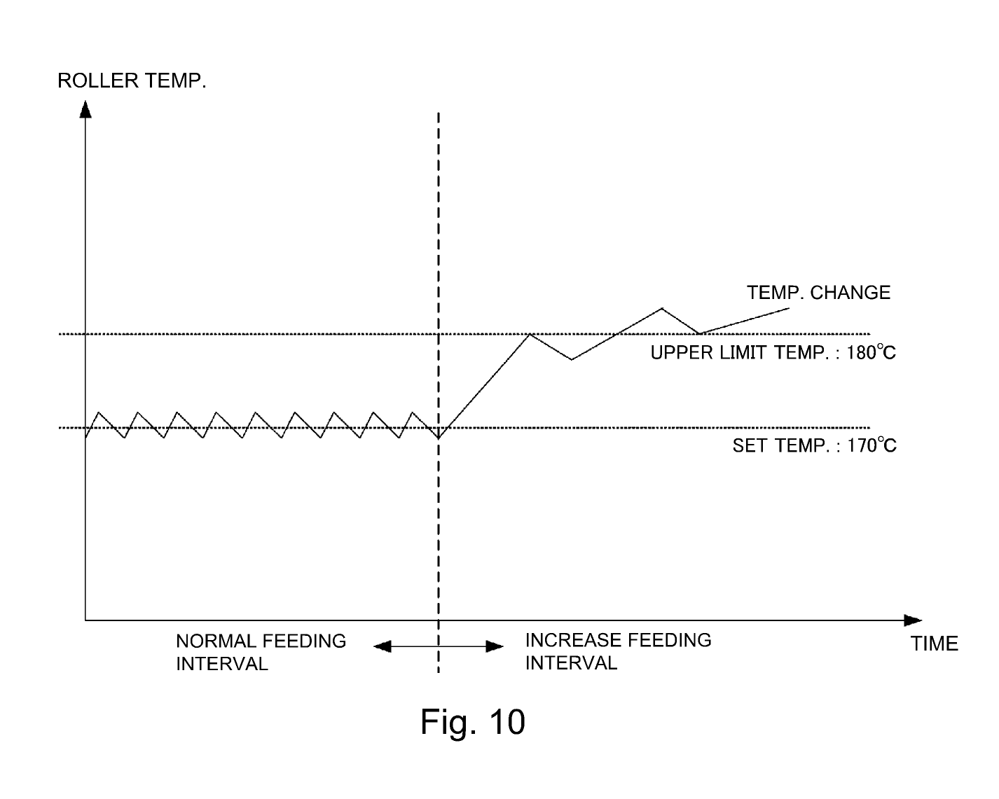

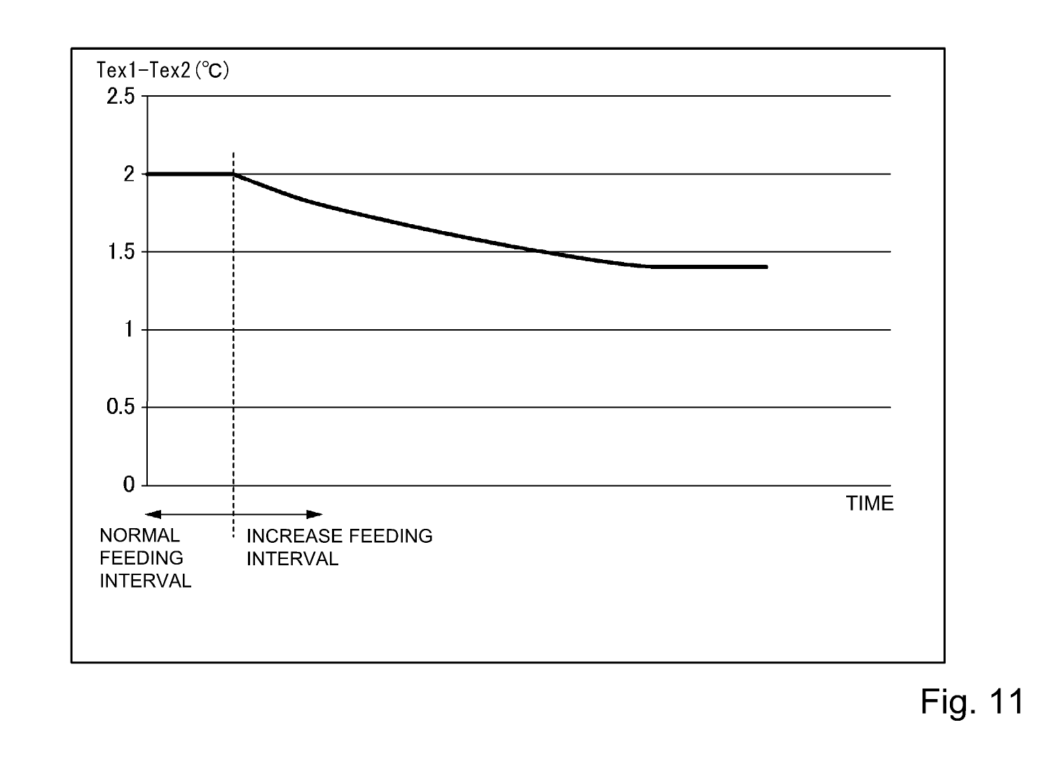

Incidentally, when the feeding interval of the recording material P is made longer than a predetermined time during image formation, the number of sheets of the recording materials P fed to the fixing nip N1 per unit time decreases, and therefore, a lowering (degree) of the surface temperature of the fixing roller 40 becomes smaller than an assumed degree. Then, the heat supply from the external heating unit 80 to the fixing roller 40 becomes excessive, so that the surface temperature of the fixing roller 40 can be higher than the target temperature. The toner image fixed on the recording material P at a temperature higher than the target temperature is liable to cause a non-uniformity in gloss and density. Further, when the surface temperature of the fixing roller 40 is high, viscosity of the toner becomes smaller than proper viscosity at which the toner image is fixed on the recording material P. In that case, a phenomenon which is called a hot offset such that the toner image is not fixed on the recording material P and the toner is deposited on the fixing roller 40 generates, so that a problem similar to that in the case where the cold offset as described above generates can arise. In the following, this point will be described using FIGS. 10 and 11.

FIG. 10 shows a time progression of the surface temperature of the fixing roller 40 in the case where the feeding interval of the recording material P (basis weight: 81 g/m² as an example) is longer than a predetermined time during image formation. In this case, during image formation, the respective halogen heaters 40a, 41a, 80c and 80d are controlled so that the surface temperature of the fixing roller 40 (fixing roller temperature) is the target temperature of 170° C. (see Table 4). However, when the feeding interval of the recording material P is longer than the predetermined time, the quantity per unit time of the heat transferred from the fixing roller 40 to the recording material P decreases. With this, the heat quantity supplied to the fixing roller 40 relatively becomes large, and therefore, as shown in FIG. 10, the surface temperature of the fixing roller 40 gradually increases and exceeds 180° C. (see Table 3) which is a proper allowable upper-limit temperature for the toner fixing. Then, the phenomenon called the hot offset generates and becomes a cause of generation of the image defect.

FIG. 11 is a graph showing a temperature difference (Tex1−Tex2) between a detection temperature Tex1 of the thermistor 81a and a detection temperature Tex2 of the thermistor 81b in the case where the feeding interval of the recording material P (basis weight: 81 g/m² as an example) is longer than the predetermined time during image formation.

As shown in FIG. 11, in the case where the recording material P is fed with a predetermined time interval, irrespective of the number of sheets of the temperatures P fed to the fixing nip N1 per unit time, the surface temperature of the fixing roller 40 lowers as estimated. For that reason, the temperature difference (Tex1−Tex2) is maintained at 2° C. As described above, this fixing device generates with supply of the heat from the external heating belt 80e to the fixing roller 40 lowering in temperature by heat transfer to the recording material P. For that reason, when the recording materials P are fed with the predetermined feeding interval, the heat transfer to the recording materials P and the heat supply from the external heating belt 80e are balanced with each other on the fixing roller 40, so that the temperature difference (Tex1−Tex2) is unchanged and is stabilized.

However, when the feeding interval of the recording material P is longer than the predetermined time and the number of sheets of the recording materials P fed to the fixing nip N1 per unit time decreases, the temperature difference (Tex1−Tex2) gradually becomes small as shown in FIG. 11. This is because the surface temperature of the fixing roller 40 is increased by the increase in feeding interval of the recording material P. That is, the surface temperature of the fixing roller 40 increases by the decrease in heat quantity transferred to the recording material P, and with this, the heat quantity supplied from the external heating belt 80e to the fixing roller 40 decreases. Then, the surface temperature of the external heating belt 80e is temperature-detected by the thermistor 81b while being high without lowering. In this case, even when the detection temperature Tex1 of the thermistor 81a is unchanged, the detection temperature Tex2 of the thermistor 81b relatively increases, so that the temperature difference (Tex1−Tex2) becomes small.

When during image formation, the temperature difference (Tex1−Tex2) becomes small, i.e., the surface temperature of the fixing roller 40 increases, the hot offset generates, so that the image defect can generate. Therefore, in the case such that the feeding interval of the recording material P is longer than the predetermined time, there is a need to decrease the surface temperature of the fixing roller 40 down to a temperature which is below at least the allowable upper-limit temperature. However, as in the above-described First Embodiment, in the case where the surface temperature of the external heating belt 80e is controlled only by the thermistor 81a during image formation, it becomes difficult to decrease the surface temperature of the fixing roller 40 down to the temperature which is below the allowable upper-limit temperature.

Therefore, in the following, a fixing device according to Third Embodiment in which the above-described problem is solved will be described. However, a constitution and a control system of the fixing device 9 according to Third Embodiment are similar to those in the above-described First Embodiment (see FIGS. 2 and 3), and therefore will be omitted from description.

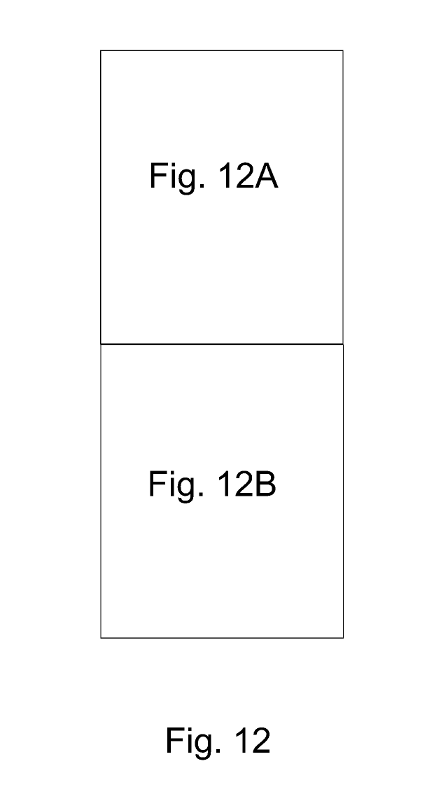

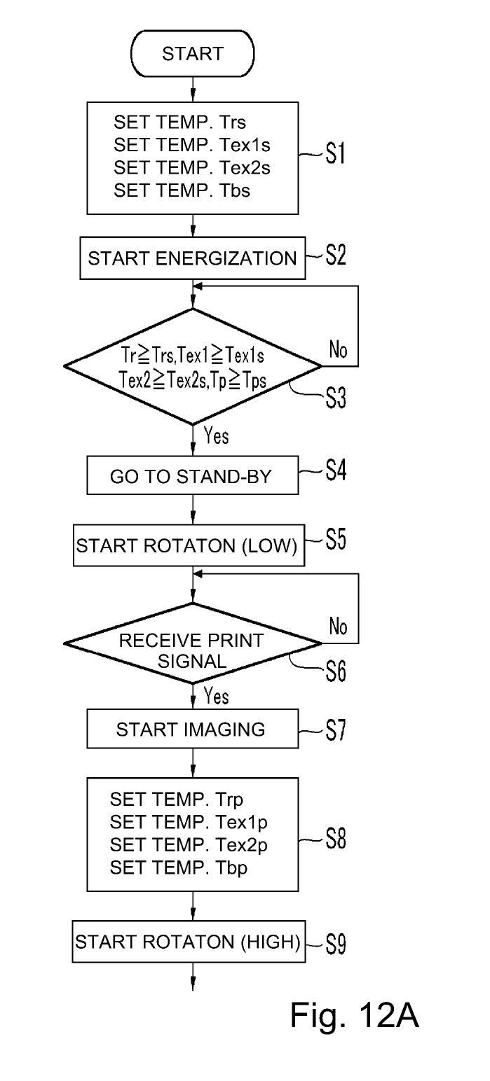

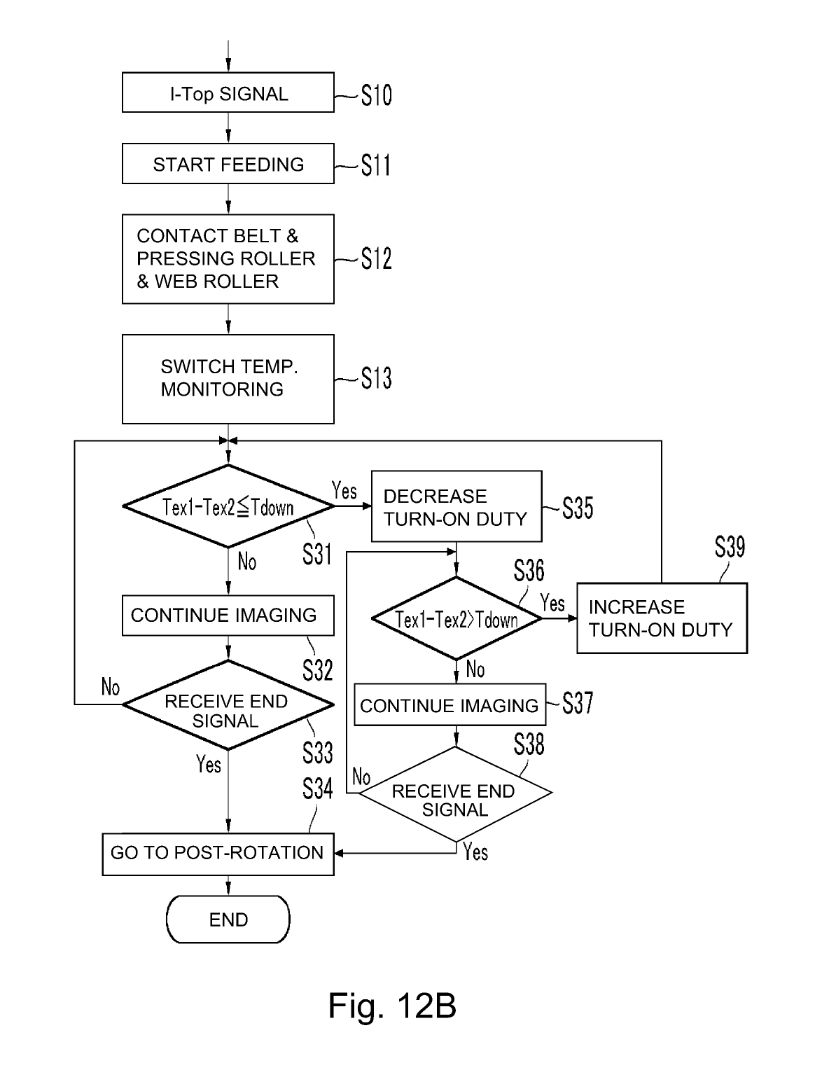

FIG. 12 is a flowchart showing the control of the fixing device in Third Embodiment. However, a portion overlapping in description with the control shown in the above-described FIG. 5 will be omitted from explanation. Further, description will be made by taking, as an example, the case where the plain paper with the basis weight of 81 g/m² is used as the recording material P during image formation.

As shown in FIG. 12 (12A, 12B), the controller 50 starts, after a process of S1 is executed, energization to the respective halogen heaters 40a, 41a, 80c and 80d of the fixing device (S2). However, the turning-on duty of the halogen heaters 80c and 80d in this case is 100%. Thereafter, the controller 50 executes respective processes of S3 to S7.

The controller 50 changes the respective target temperatures to a target temperature Trp of the fixing roller temperature, a target temperature Tex1p of the external heating upstream temperature, a target temperature Tex2p of the external heating downstream temperature and a target temperature Tbp of the surface temperature of the pressing roller 41, which are to be used during image formation (S8). From the above-described Table 4, the target temperature Trp of the fixing roller temperature used during image formation is changed to 170° C., and the target temperature Tex1p of the external heating upstream temperature and the target temperature Tex2p of the external heating downstream temperature which are used during image formation are changed to 210° C. The target temperature Tbp of the surface temperature of the pressing roller 41 is 100° C. At this time, the turning-on duty is changed to 40% in accordance with the setting for the basis weight of 81 g/m², and the halogen heaters 80c and 80d are energized. That is, the halogen heaters are repetitively energized for 2 seconds with an interval of 3 seconds.

After execution of the respective processes S9 to S12, the controller 50 changes the temperature control of the external heating belt 80e so as to be carried out on the basis of only the temperature detected by the thermistor 81a for detecting the external heating upstream temperature (S13). That is, when the contact state of the external heating belt 80e is detected, the controller 50 causes, on the basis of the temperature detected by the thermistor 81a, both of the halogen heaters 80c and 80d simultaneously so as to be subjected to the ON-OFF controllable. However, in this Third Embodiment, even when the halogen heaters 80c and 80d are simultaneously subjected to the ON control, these heaters 80c and 80d are repetitively subjected to the energization (ON) and the non-energization (OFF) with a predetermined time interval in accordance with the turning-on duty. Thus, the overshooting of the surface temperature of external heating belt 80e after the image formation is suppressed.

The controller 50 discriminates whether or not the temperature difference (Tex1−Tex2) between the detection temperature Tex1 of the thermistor 81a and the detection temperature Tex2 of the thermistor 81b is not more than a temperature difference Tdown (0.3° C., for example) as a second predetermined value (S31). In the case where the temperature difference (Tex1−Tex2) is larger than the predetermined temperature difference Tdown (NO of S31), the controller 50 continues image formation without changing the turning-on duty of the halogen heaters 80c and 80d from 40% (S32). That is, in this case, the temperature of the detection temperature Tex2 of the thermistor 81b does not largely increase, so that the temperature difference with the detection temperature Tex1 of the thermistor 81a is not small. For that reason, there is a small liability that the surface temperature of the fixing roller 40 becomes a high temperature exceeding the allowable upper-limit temperature, so that there is no need to carry out control of decreasing the external heating downstream temperature in order to decrease the surface temperature of the fixing roller 40, i.e., control of decreasing the turning-on duty of the halogen heater 80d.

The controller 50 discriminates whether or not a print end signal is received (S33), and in the case where the print end signal is not received (NO of S33), the process is returned to the process of the above-described S31. In the case where the print end signal is received (YES of S33), a post-rotation operation is performed (S34), and the process is ended. In the post-rotation operation in this embodiment, the controller 50 executes the process S15 to S17 of FIG. 5 as already been described above.

On the other hand, in the case where the temperature difference (Tex1−Tex2) is not more than the second predetermined value, i.e., not more than predetermined temperature difference Tdown (YES of S31), the controller 50 decreases the turning-on duty of the halogen heater 80d of those of the halogen heaters 80c and 80d (S35). For example, the controller 50 decreases the turning-on duty, which was 40%, down to 0%. In the case where the turning-on duty is 0%, the halogen heater 80d is not turned on. That is, in this case, the temperature of the detection temperature Tex2 of the thermistor 81b largely increases, so that the temperature difference with the detection temperature Tex1 of the thermistor 81a becomes small. For that reason, there is a liability that the surface temperature of the fixing roller 40 becomes a high temperature exceeding the allowable upper-limit temperature. Therefore, in order to decrease the surface temperature of the fixing roller 40, control of decreasing the external heating downstream temperature, i.e., control of decreasing the turning-on duty of the halogen heater 80d is effected.

The controller 50 discriminates whether or not the temperature difference (Tex1−Tex2) is larger than the predetermined temperature difference Tdown after the process of S35 (S36). In the case where the temperature difference (Tex1−Tex2) is not more than the predetermined temperature difference Tdown (NO of S36), the controller 50 continues the image formation without returning the turning-on duty of the halogen heater 80d from 0%, after the change, to the original value (S37). That is, in a period in which the temperature difference (Tex1−Tex2) is not more than the predetermined temperature difference Tdown, there is a liability that the surface temperature of the fixing roller 40 becomes high temperature exceeding the allowable upper-limit temperature, and therefore, there is a need to subsequently decrease the external heating downstream temperature. For that reason, the halogen heater 80d is energized in accordance with the decreased turning-on duty after the change.

The controller 50 discriminates whether or not a print end signal is received (S38), and in the case where the print end signal is not received (NO of S38), the process is returned to the process of the above-described S36. In the case where the print end signal is received (YES of S38), a post-rotation operation is performed (S34), and the process is ended. In the post-rotation operation in this embodiment, the controller 50 executes the process S15 to S17 of FIG. 5 as described above.

In the above-described process of S36, in the case where the temperature difference (Tex1−Tex2) is larger than the predetermined temperature difference Tdown (YES of S36), the controller 50 returns the turning-on duty of the halogen heater 80d to the turning-on duty before the change, i.e., the original value (S39). For example, the controller 50 increases the turning-on duty, which was 0%, to 40%. That is, control of decreasing the turning-on duty of the halogen heater 80d (see S35), and therefore, the external heating downstream temperature decreases, so that the surface temperature of the fixing roller 40 becomes a temperature which is below the allowable upper-limit temperature. However, when the surface temperature of the fixing roller 40 is further decreased, there is a liability that the surface temperature becomes a low temperature which is below the fixable temperature. Therefore, the turning-on duty of the halogen heater 80d is increased and returned to the original value, whereby a further decrease in surface temperature of the fixing roller 40 is suppressed. After the process of S39, the process is returned to the above-described process of S31, and the controller 50 repeats the processes of S31 to S39.

As described above, also in Third Embodiment, during image formation, the halogen heater 80d in the downstream side with respect to the rotational direction of the fixing roller 40 is ON-OFF controlled, on the basis of the detection temperature of the thermistor 81a in the upstream side with respect to the rotational direction of the fixing roller 40, simultaneously with the halogen heater 80c. Then, on the basis of a difference in detection temperature between the two thermistors 81a and 81b, control of decreasing the turning-on duty of the halogen heater 80d is carried out in the case where the heat quantity supplied from the external heating belt 80e to the fixing roller 40 is excessive. By this, the feeding interval of the recording material P is longer than the predetermined time, and even when the number of sheets of the recording materials P fed to the fixing nip N1 per unit time is decreased, it is possible to carry out optimum heat supply from the external heating unit 80 to the fixing roller 40. For that reason, the image formation is not effected while making the surface temperature of the fixing roller 40 higher than a necessary target temperature. Accordingly, the image defect with the generation of the hot offset is not readily generated.

Incidentally, in Third Embodiment, in the case where the temperature difference (Tex1−Tex2) is not more than the predetermined temperature difference Tdown, the turning-on duty of only the halogen heater 80d is changed (see S35), but the present invention is not limited thereto, and the turning-on duty of both of the halogen heaters 80c and 80d may also be changed. In that case, in the above-described process of S36, when the temperature difference (Tex1−Tex2) is not more than the predetermined temperature difference Tup, the turning-on duty of the both of the halogen heaters 80c and 80d is returned to the turning-on duty before the change (S39).

Incidentally, in the above-described First to Third Embodiments, as regards the halogen heaters 80c and 80d, those having the same normal rated power were used, but the halogen heaters are not limited thereto, and heaters different in normal rated power may also be used. In that case, as the halogen heater 80d, a heater having normal rated power lower than that of the halogen heater 80c is used. This is because when the normal rated power of the halogen heater 80d is larger than that of the halogen heater 80c, it becomes difficult to suppress the overshooting of the surface temperature of the external heating belt 80e after the image formation. That is, when the normal rated power of the halogen heater 80d is large, an output of the halogen heater 80d becomes large although also the halogen heater 80d is subjected to the ON-OFF control on the basis of the temperature detected by the thermistor 81a. Then, the surface temperature of the external heating belt 80e can overshoot after the image formation. In order to avoid this, the halogen heater 80d having the normal rated power which is not more than the normal rated power of the halogen heater 80c is used. Further, each of the halogen heaters 40a, 41a, 80c and 80d may be a single heater having a specific light distribution, but is not limited thereto, and may also include a plurality of heaters having different light distributions.

Incidentally, in the above-described First to Third Embodiments, the fixing roller 40 provided with the halogen heater 40a therein was employed, but a constitution in which the fixing roller 40 is not provided with a heater and in which the fixing roller 40 is heated only by the external heating unit 80 may also be employed. Further, in the above-described embodiments, the pressing roller 41 provided with the halogen heater 41a therein was employed, but a constitution in which the pressing roller 41 is not provided with a heater may also be employed. Further, the pressing roller 41 provided with the elastic layer on the core metal was employed, but is not limited thereto, and may also be in other forms, such as a pressing belt, and a pressing roller and a pressing belt which have elastic layer.

Incidentally, in the above-described First to Third Embodiments, as the heating means, the halogen heater was employed. However, as the heating means, other heating means, other than the halogen heater, such as a heating means of an electromagnetic induction heating type and a planar heat generating member may also be used. Further, in the above-described First to Third Embodiments, to each of the halogen heaters, electric power equal to associated normal rated power is supplied. However, even in the case where electric power less than the normal rated power is supplied, it is only required that values of maximum electric power supplied to the halogen heaters 80c and 80d are made the same and the turning-on duty is changed as desired.

### Fourth Embodiment

### [Image Forming Apparatus]

An image forming apparatus to which a fixing device according to Fourth Embodiment is applicable will be described using FIG. 1. An image forming apparatus 100 shown in FIG. 1 is an intermediary transfer type full-color printer of a tandem type in which image forming portions Pa, Pb, Pc and Pd for yellow, magenta, cyan and black are arranged along an intermediary transfer belt 20.

First, a feeding process of a recording material in this image forming apparatus 100 will be described. The recording material P is accommodated in the form of being stacked in a recording material accommodating container (sheet feeding cassette) 10, and is fed by a feeding roller 13 by being timed to image forming timing. In sheet feeding from the recording material accommodating container 10, for example, a friction separation type or the like is used. The recording material P fed by the feeding roller 13 is fed to registration rollers 12 provided at a halfway portion of a feeding path 114. Further, the recording material P is sent to a secondary transfer portion T2 after oblique movement correction and timing correction of the recording material P are carried out in the registration roller 12. The secondary transfer nip T2 is a transfer nip formed by opposing inner secondary transfer roller 21 and outer secondary transfer roller 11, and the toner image is attracted onto the recording material by applying a predetermined pressing force and a predetermined electrostatic load bias.

Relative to the above-described feeding process of the recording material P to the secondary transfer portion T2, a forming process of the image sent to the secondary transfer portion T2 at similar timing will be described. First, the image forming portions are described, but the image forming portions Pa, Pb, Pc and Pd for the respective colors are substantially similarly constituted except that colors of the toners are yellow, magenta, cyan and black, which are different from each other. Therefore, in the following, as a representative, the image forming portion Pb for black is described, and as regards other image forming portions Pa, Pb and Pc, the suffix d of symbols in the description is to be described by being read as a, b and c.

The image forming portion Pd is principally constituted by a developing device 1d, a charging device 2d, a photosensitive drum 3d, a photosensitive drum cleaner 4d and an exposure device 5d and the like. In the figure, a surface of the photosensitive drum 3d rotationally driven in R1 direction is electrically charged uniformly in advance by the charging device 2d, and thereafter, an electrostatic latent image is formed by the exposure device 5d driven on the basis of a signal of image information. Then, the electrostatic latent image formed on the photosensitive drum 3d is subjected to toner development by the developing device 1d and is visualized. Thereafter, a predetermined pressing force and a predetermined electrostatic load bias are applied by a primary transfer roller 6d provided opposed to the image forming portion Pd by sandwiching the intermediary transfer belt 20 therebetween, so that the toner image formed on the photosensitive drum 3d is primary-transferred onto the intermediary transfer belt 20. Primary transfer residual toner remaining on the photosensitive drum 3d in a slight amount is collected by the photosensitive drum cleaner 4d and is prepares for a subsequent image forming process. As regards the image forming portion Pd described above, in the case of a structure shown in FIG. 1, four sets for yellow, magenta, cyan and black exist. However, the number of the colors is not limited to four (colors), and also an arrangement order of the colors is not limited thereto. The developing device 1d uses, as a developer, a two-component developer in which the toner and a magnetic carrier are mixed, for example.

The intermediary transfer belt 20 will be described. The intermediary transfer belt 20 is an endless belt which is stretched by the inner secondary transfer roller 21, a tension roller 22 and a stretching roller 23 and which is fed and driven in an arrow R2 direction in the figure. Here, the inner secondary transfer roller 21 also functions as a driving roller for driving the intermediary transfer belt 20. Image forming processes for the respective colors to be processed in parallel by the image forming portions P are carried out at timing when the toner images are successively superposed on the toner image(s) for the upstream(-side) color(s) primary-transferred on the intermediary transfer belt 20. As a result, finally, a full-color toner image is formed on the intermediary transfer belt 20 and is fed to the secondary transfer portion T2. Incidentally, secondary transfer residual toner after passed through the secondary transfer portion T2 is collected by a transfer cleaner device 30.

As described above, by the feeding process and the image forming process which are described, respectively, timing of the recording material P and timing of the full-color toner image coincide with each other, so that secondary transfer is carried out. Thereafter, the recording material P is fed to a fixing device 9 (image heating apparatus), and predetermined pressure and predetermined heat quantity are applied to the recording material P, so that the toner image is melt-fixed on the recording material. Thus, the recording material P on which the image is fixed is subjected to selection by discharging rollers 14 such that the recording material P is discharged onto a sheet discharge tray 120 or subjected to double-side image formation.

In the case where the double-side image formation is required, by a switching member 110 (called a flapper or the like), the feeding path is switched from a path leading to the sheet discharge tray 120 to a double-side feeding path 111, so that the recording material P fed by the sheet discharging rollers 14 is fed to the double-side feeding path 111. Thereafter, in synchronism with timing of a recording material P, in a subsequent job, fed from the feeding roller 13, leading and trailing ends of the recording material P (fed along the feeding path 112) are replaced with each other, and is sent again to the feeding path 114 via a double-side path 113. As regards subsequent feeding and image forming process on the back surface, they are similar to those described above, and therefore, description will be omitted.

Further, the image forming apparatus 100 includes an operating portion S and a controller 50. The operating portion S includes a display portion (not shown) of displaying various pieces of information, operating keys (not shown) through which user input is received, and the like. A user is capable of providing a start instruction of an image forming job by using the operation keys of the operating portion S or selectively inputting image quality setting of the image and the various species of information (for example, a type, a basis weight and the like of paper) of the recording material P set in the recording material accommodating container 10, from pieces of information displayed at the display portion. The controller 50 determines an image forming condition in accordance with inputted information, and controls respective portions of the image forming apparatus 100 in order to effect the image formation under the image forming condition. The controller 50 carries out control of the fixing device 9 during execution of the image forming job, so that the recording material P is heated at a predetermined temperature and the toner image is heat-fixed. As regards the control of such a fixing device 9, description is made layer, and therefore, detailed description will be omitted here.

### [Fixing Device]

Next, a structure of the fixing device 9 will be described using FIG. 2. As shown in FIG. 2, the fixing device 9 includes a fixing roller 40 as a first rotatable member and a pressing roller 41 as a second rotatable member. The fixing roller 40 and the pressing roller 41 are rotatably shaft-supported by a housing (not shown) of the fixing device 9 via ball bearings (not shown) or the like. The fixing roller 40 and the pressing roller 41 are omitted from illustration in the figure, but gears fixed to one shaft ends thereof are connected with each other via a gear mechanism, and are integrally rotationally driven by a driving source (not shown) such as a motor via the gear mechanism.

The fixing roller 40 is formed by superposing a heat-resistant elastic layer 40c and a heat-resistant parting layer 40d, from an inner diameter side in the order named, on a metal-made core metal 40b formed in a cylindrical shape. For example, the core metal 40b of the fixing roller 40 is made of aluminum of 77 mm in outer diameter, 6 mm in thickness and 350 mm in length. The elastic layer 40c is formed with a 3 mm-thick HTV (high-temperature vulcanization type) silicone rubber, and coats an outer peripheral surface of the core metal 40b. The parting layer 40d is formed with a 50 μm-thick fluorine-containing resin material (for example, a PFA tube) in order to improve a parting property and coats a surface of the elastic layer 40c.

At an inner portion of the core metal 40b of the fixing roller 40, a halogen heater 40a of, e.g., 1200 W in normal rated power, which is subjected to output control by energization and which thus generates heat is provided non-rotatably almost over an entirety of the fixing roller 40 with respect to a widthwise direction (longitudinal direction, axial direction). The halogen heater 40a heats the fixing roller 40 from an inside of the fixing roller 40 so that a surface temperature of the fixing roller 40 is a predetermined target temperature. The surface temperature of the fixing roller 40 is detected by a thermistor 42a. Then, on the basis of this detection temperature, the halogen heater 40a is subjected to ON (energization) or OFF (non-energization) control by the controller 50 (see FIG. 1), so that the surface temperature of the fixing roller 40 is adjusted to the predetermined target temperature.

The pressing roller 41 is formed by superposing a heat-resistant elastic layer 41c and a heat-resistant parting layer 41d, from an inner diameter side in the order named, on a metal-made core metal 41b formed in a cylindrical shape. For example, the core metal 41b of the pressing roller 41 is made of aluminum of 59 mm in outer diameter, 5 mm in thickness and 350 mm in length. The elastic layer 41c is formed with a 1 mm-thick HTV silicone rubber, and coats an outer peripheral surface of the core metal 41b. The parting layer 41d is formed with a 50 μm-thick fluorine-containing resin material (for example, a PFA tube) and coats a surface of the elastic layer 41c.

At an inner portion of the core metal 41b of the pressing roller 41, a halogen heater 41a of, e.g., 400 W in normal rated power, which generates heat by energization is provided non-rotatably almost over an entirety of the pressing roller 41 with respect to a widthwise direction (longitudinal direction, axial direction). The halogen heater 41a heats the pressing roller 41 from an inside of the pressing roller 41 so that a surface temperature of the pressing roller 41 is a predetermined target temperature. The surface temperature of the pressing roller 41 is detected by a thermistor 42b. Then, on the basis of this detection temperature, the halogen heater 41a is subjected to the ON-OFF control by the controller 50 (see FIG. 1), so that the surface temperature of the pressing roller 41 is adjusted to a certain temperature of 100° C., for example.

The above-described pressing roller 41 is press-contacted to the fixing roller 40 with predetermined pressure, such as pressure of 784 N (about 80 kgf), and forms a fixing nip N1 in cooperation with the fixing roller 40. The recording material P is heated and pressed by being nipped and fed at the fixing nip N1. For that reason, the fixing roller 40 is rotated in an arrow R3 direction in the figure and the pressing roller 41 is rotated in an arrow R4 direction in the figure so that the fixing roller 40 and the pressing roller 41 are rotated in the same direction at the fixing nip N2. Further, the pressing roller 41 is movable between a contact (mounted) state in which the pressing roller 41 is press-contacted to the fixing roller 40 and a spaced (demounted) state in which the predetermined roller 41 is spaced from the fixing roller 40, by an unshown a pressing mounting and demounting (contacting and spacing) mechanism. The (contact)/(spaced) state of the pressing roller 41 is discriminated by the controller 50.

### [Cleaning Unit]

Further, the fixing device 9 includes a cleaning unit 60 as a cleaning member for the fixing roller 40. The cleaning unit 60 includes a cleaning web 61 which is a nonwoven fabric, a collecting roller 62 and a web roller 63. The collecting roller 62 is a stainless steel-made cylindrical member formed of 20 mm in diameter, for example. The collecting roller 62 is provided rotatably in a state in which the collecting roller 62 is contacted to the fixing roller 40 over almost an entirety of the fixing roller 40 with respect to the widthwise direction (longitudinal direction, the axial direction), and collects the toner deposited on the fixing roller 40 without being fixed on the recording material P. The collecting roller 62 is always contacted to the fixing roller 40 and is rotated by the fixing roller 40.

The web roller 63 supports the cleaning web 61 and presses (urges) the supported cleaning web 61 against the collecting roller 62 with a force of, e.g., about 40 N. The cleaning web 61 is pressed against the collecting roller 62, and thus wipes off the toner, on the cleaning roller 62, collected from the fixing roller 40. The cleaning web 61 is wound up in one direction (arrow X direction in the figure), and therefore, a fresh surface, of the cleaning web 61, where the toner is not wiped off is always supplied to a contact surface with the collecting roller 62. The web roller 63 is movable between a contact state in which the web roller 63 is press-contacted to the collecting roller 62 and a spaced state in which the web roller 63 is spaced from the collecting roller 62, by an unshown web mounting and demounting (contacting and spacing) mechanism. Incidentally, the collecting roller 62 is press-contacted to the fixing roller 40 with a force (urging) of about 10 N in the spaced state of the web roller 63 and with a force of about 50 N, obtained by adding about 40 N of the web mounting and demounting mechanism to the force of about 10 N, in the contact state of the web roller 63. The mounting/demounting state of the web roller 63 is discriminated by the controller 50.

### [Externally Heating Unit]

In the image forming apparatus, even the recording material, such as temperature difference, having a large basis weight (weight per unit area) is required to provide high productivity (the number of printed sheets per unit time). In order to enhance the productivity for the recording material having the large basis weight, there is a need to increase a speed of a heating process in the fixing device 9. However, the recording material having the large basis weight takes heat in a large amount, and therefore a heat quantity required for fixing becomes large compared with a recording material having a small basis weight. Therefore, as shown in FIG. 2, the fixing device 9 includes an external heating unit 80 as an external heating device, and heats the fixing roller 40 from an outside of the fixing roller 40 by the external heating unit 80 as desired. More specifically, in the case where much heat is transferred from the fixing roller 40 to the recording material P, the external heating unit 80 is provided for quickly replenishing the heat quantity corresponding to an amount of heat delayed in supply by the halogen heater 41a in the pressing roller 41. The external heating unit 80 (specifically an external heating belt 80e heats the fixing roller 40 by contacting the fixing roller 40).

The external heating unit 80 includes the external heating belt 80e, an external heating roller 80a as a first roller for stretching the external heating belt 80e, an external heating roller 80b as a second roller, and halogen heaters 80c and 80d as an external heating means. The external heating belt 80e as a belt member is a belt formed by coating a heat-resistant sliding layer formed of a fluorine-containing resin material (e.g., a PFA tube) on a metal-made base material of stainless steel or the like formed in an endless belt shape, for example. The external heating belts 80a and 80b are formed, similarly as the fixing roller 40 and the pressing roller 41, by coating a heat-resistant sliding layer formed of a fluorine-containing resin material (e.g., a PFA tube) on a metal-made core metal of aluminum or the like formed in a cylindrical shape, for example.

The external heating unit 80 is movable between a contact state in which the external heating unit 80 is press-contacted to the fixing roller 40 by the external heating belt 80e and a spaced state in which the external heating belt 80e is spaced from the fixing roller 40, by a belt mounting and demounting (contacting and spacing) mechanism (see FIG. 4 described later). The contact/spaced state of the external heating unit 80 is discriminated by the controller 50.

In the case where the external heating unit 80 is in the mounted state, the external heating rollers 80a and 80b are press-contacted to the external heating belt 80e toward the fixing roller 40 with predetermined pressure. Then, the external heating belt 80e contacts the surface of the fixing roller 40, and forms an external heating contact portion N2. That is, the external heating belt 80e forms a broad external heating contact portion N2 in cooperation with the fixing roller 40 and is provided for increasing the heat quantity supplied to the fixing roller 40.

The external heating belt 80e and the external heating rollers 80a and 80b are rotated by the fixing roller 40 (arrow R5 direction in the figure). These external heating rollers 80a and 80b are disposed so as to sandwich the external heating contact portion N2 therebetween with respect to a rotational direction of the external heating belt 80e. Further, the external heating rollers 80a and 80b are disposed so that the external heating roller 80a of these rollers is adjacent to an upstream portion of the external heating contact portion N2 and so that the external heating roller 80b of these rollers is adjacent to a downstream portion of the external heating contact portion N2, respectively. That is, the external heating belt 80a is disposed, with respect to the rotational direction (arrow R3 direction in the figure) of the fixing roller 40, in a side upstream of the external heating roller 80b and upstream of the external heating contact portion N2.

Inside the external heating roller 80a, a halogen heater 80c, of, e.g., 1500 W in normal rated power, generating heat by energization is fixedly provided as a first heating means over almost an entirety of the external heating roller 80a. Inside the external heating roller 80b, a halogen heater 80d, of, e.g., 1500 W in normal rated power, generating heat by energization is fixedly provided as a second heating means over almost an entirety of the external heating roller 80b. In this embodiment, to the respective halogen heaters 80c and 80d, electric power which is the same as the normal rated power is supplied. Incidentally, the above-described widthwise direction is also longitudinal directions and rotational axis directions of the external heating rollers 80a and 80b.

Further, the external heating unit 80 includes a toner 81a as a first temperature detecting means and a thermistor 81b as a second temperature detecting means. The thermistor 81a is provided at a position where the thermistor 81a contacts the external heating roller 80a at a portion, of an outer peripheral surface of the external heating belt 80e in an upstream side with respect to the rotational direction of the fixing roller 40, and detects a temperature of the external heating belt 80e in a region in which the external heating roller 80a contacts the external heating belt 80e. The thermistor 81b is provided at a position where the thermistor 81b contacts the external heating roller 80b at a portion, of an outer peripheral surface of the external heating belt 80e in an downstream side with respect to the rotational direction of the fixing roller 40, and detects a temperature of the external heating belt 80e in a region in which the external heating roller 80b contacts the external heating belt 80e.

### [Controller]

The controller 50 (see FIG. 1) subjects the halogen heaters 80a and 80b to ON-OFF control on the basis of temperatures detected by the thermistors 81a and 81b in order to adjust a surface temperature of the external heating belt 80e, and by extension to a surface temperature of the fixing roller 40. However, the controller 50 subjects, during preparation of the image formation, the halogen heater 80c to the ON-OFF control on the basis of the temperature detected by the thermistor 81a and the halogen heater 80d to the ON-OFF control on the basis of the temperature detected by the thermistor 81b respectively. Further, the controller 50 subjects, during image formation, both of the halogen heaters 80c and 80d to the ON-OFF control on the basis of the temperature detected by the temperature 81a.

Here, during image formation is a period from a start of image formation based on a print signal for forming the image on the recording material P to completion of an image forming operation. Specifically, during image formation refers to a period from during pre-rotation after receipt of the print signal (input of an image forming job) to post-rotation (operation after the image formation), and is a period including an image forming period and a sheet interval (during non-image formation). During preparation of the image formation is a state in which a power source of the image forming apparatus 100 is turned on, but the image forming job is not executed. As described above, during image formation is a series of operations including from a pre-rotation operation, the image forming period, the sheet interval and the post-rotation, and therefore during preparation of the image formation refers to a period in which this services of operations is not executed in a state in which the electric power of the image forming apparatus 100 is turned on. Further, during preparation of the image formation includes during stand-by (stand-by state), and during stand-by (or stand-by state) is a state in which after the power source of the image forming apparatus 100 is turned on or after the image formation, the image forming apparatus 100 waits for receipt of the print signal in a state in which the series of operations during image formation described above is capable of being performed.

The controller 50 subjects the halogen heaters 80c and 80d to the ON-OFF control, and adjusts the surface temperature of the external heating belt 80e, and by extension to the surface temperature of the fixing roller 40, to a predetermined target temperature. In Table 1, target temperatures (represented as setting temperatures in the table) of the fixing roller 40 and the external heating belt 80e which are used during stand-by and during image formation are shown, respectively. The controller 50 subjects, as described above, the halogen heaters 40a and 41a and the halogen heaters 80c and 80d to the ON-OFF control, and adjusts the surface temperature of the external heating belt 80e, and by extension to the surface temperature of the fixing roller 40, to the target temperatures shown in Table 1. As shown in Table 1, the target temperatures of the fixing roller 40 and the external heating belt 80e are determined depending on the basis weight of the recording material P.

TABLE 5

| Recording material basis weight (g/m²) | | | | | |
|---|---|---|---|---|---|
| 60-79 | 80-99 | 100-149 | 150-199 | 200-249 | 250-350 |

| FRST*¹ | 165 (° C.) | |
|---|---|---|
| TDSB*² | | |
| FRST*¹ | 170 (° C.) | |
| TDIF*³ | | |
| EHBST*⁴ | 190 (° C.) | |
| TDSB⁺² | | |
| EHBST*⁴ | 210 (° C.) | 215 |
| TDIF*³ | | |

*¹“FRST” is the fixing roller setting temperature.
*²“TDSB” is the temperature during stand-by.
*³“TDIF” is the temperature during image formation.
*⁴“EHBST” is the external heating belt setting temperature.

Next, the control of the fixing device 9 will be described. First, FIG. 3 shows a block diagram of a control system of the fixing device 9. The controller 50 is a computer such as a CPU for controlling respective portions of the fixing device 9, and includes a memory 51 as shown in FIG. 3. The memory 51 is ROM, RAM or the like, and stores various programs, data and the like for controlling the image forming apparatus 100. Further, the memory 51 can also temporarily store a calculation process (computation) result with execution of the program. The controller 50 is connected with the operating portion S (see FIG. 1) via an unshown interface, and receives execution start operations of the various programs such as the image forming job by a user or various data inputs by the user, or the like. The controller 50 controls, depending on the execution of the image forming job, the respective portions connected thereto via unshown interfaces and described later, and thus operates the fixing device 9.

To the controller 50, the belt mounting and demounting mechanism 57 is connected. The belt mounting and demounting mechanism 57 moves the external heating unit 80 so as to be movable toward and away from the fixing roller 40. By this, the fixing device 9 is in a state which is either of a contact state in which the fixing roller 40 and the external heating belt 80e are press-contacted to each other or a spaced state in which the fixing roller 40 and the external heating belt 80e are spaced from each other.

The controller 50 individually controls a plurality of driving motors 54 via a motor controller 52 and a motor driver 53. The respective driving motors 54 rotationally drive the fixing roller 40 and the pressing roller 41 in predetermined directions at predetermined speeds, respectively, depending on control by the controller 50. Further, the controller 50 individually subjects the halogen heaters 40a, 41a, 80c and 80d to the ON/OFF control via a heater controller 55 and a heater driver 56. As already described above, depending on control of the halogen heater 40a, the surface temperature of the fixing roller 4 is adjusted, and depending on control of the halogen heater 41a, the surface temperature of the pressing roller 41 is adjusted. Further, depending on the halogen heaters 80c and 80d, the surface temperature of the external heating belt 80e is adjusted.

To the controller 50, the thermistors 42a, 42b, 81a and 81b are connected via unshown interfaces. The controller 50 acquires the surface temperature of the fixing roller 40 (hereinafter, referred to as a fixing roller temperature for convenience) from the thermistor 42a and acquires the surface temperature of the pressing roller 41 from the thermistor 42b. Further, the controller 50 acquires the surface temperature of the external heating belt 80e in an upstream side with respect to a fixing roller rotational direction (hereinafter, referred to as a an external heating upstream temperature for convenience) from the thermistor 81a. Further, the controller 50 acquires the surface temperature of the external heating belt 80e in a downstream side with respect to the fixing roller rotational direction (hereinafter, referred to as an external heating downstream temperature for convenience) from the thermistor 81b. The controller 50 subjects the halogen heaters 40a, 41a, 80c and 80d to the ON-OFF control on the basis of temperatures detected by the temperatures 42a, 42b, 81a and 81b, and thus carries out control of adjusting the surface temperature of the fixing roller 40 to a predetermined target temperature.

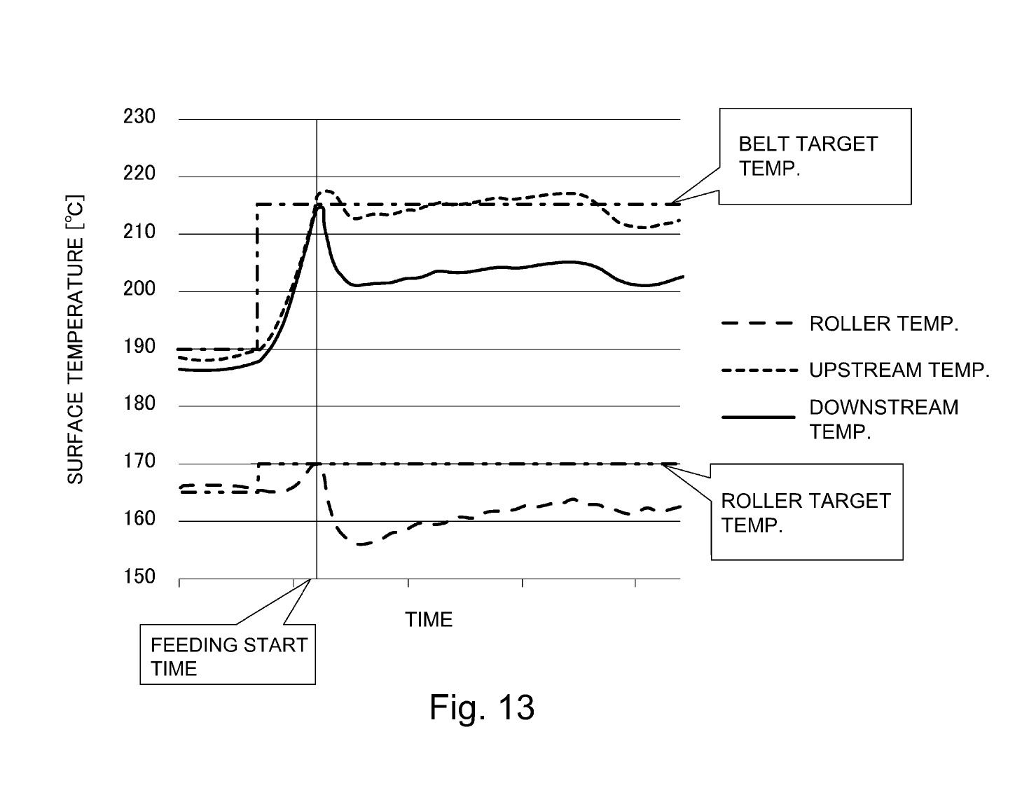

Here, in FIG. 13, in the case where image formation is carried out on a large number of sheets of thick paper (basis weight: 250 g/m² as an example) by using a fixing device in a comparison example, time progressions of the fixing roller temperatures, the external heating upstream temperatures and the external heating downstream temperatures detected by the thermistors 42a, 81a and 81b are shown. In the fixing device in the comparison example, with regard to the external heating unit 80, the control of the halogen heater 80c is carried out on the basis of the temperature detected by the thermistor 81a, and the control of the halogen heater 80d is carried out on the basis of the temperature detected by the thermistor 81b. In FIG. 4, the ordinate represents the surface temperature, and the abscissa represents the time. In this case, a target temperature Trp of the fixing roller temperature used during image formation is 170° C., and a target temperature Tex1p (first target temperature) of the external heating upstream temperature and a target temperature Tex2p (second target temperature) of the external heating downstream temperature which are used during image formation are 215° C. (see Table 1). Incidentally, a target temperature of the surface temperature of the pressing roller 41 is always 100° C.

As shown in FIG. 13, when the recording material P enters the fixing nip N1 for toner fixing (see feeding start time), heat transfers from the fixing roller 40 to the recording material P, so that the fixing roller temperature lowers. When the fixing roller temperature lowers, the heat is supplied from the external heating belt 80e to the fixing roller 40, and therefore, also the external heating upstream temperature and the external heating downstream temperature lower. The external heating downstream temperature follows the lowering in fixing roller temperature, i.e., lowers simultaneously with entrance of the recording material P into the fixing nip N1. On the other hand, the external heating upstream temperature does not lower simultaneously with the entrance of the recording material P into the fixing nip N1 and lowers with a delay after the entrance of the recording material P into the fixing nip N1.

The thermistor 81b is disposed in a downstream side with respect to the rotational direction of the fixing roller 40 and detects the surface temperature (external heating downstream temperature) of the external heating belt 80e immediately after the heat supply to the fixing roller 40 is carried out, and therefore followability to the lowering in surface temperature of the fixing roller 40 is good. Accordingly, the external heating downstream temperature lowered simultaneously with the entrance of the recording material P into the fixing nip N1 is detected. On the other hand, the thermistor 81a is disposed in a upstream side with respect to the rotational direction of the fixing roller 40 and detects the surface temperature (external heating downstream temperature) of the external heating belt 80e temperature-recovered (restored) by the external heating rollers 80a and 80b after the heat supply to the fixing roller 40 is carried out. For that reason, followability to the lowering in surface temperature of the fixing roller 40 is not good, so that supply of the electric power to the halogen heater 81d is delayed. Accordingly, the external heating upstream temperature lowered with a delay after the entrance of the recording material P into the fixing nip N1 is detected.

When the supply of the electric power to the halogen heater 81d in an external heating upstream side is delayed, the surface temperature of the fixing roller 40 can be lower than the fixable temperature. When the surface temperature of the fixing roller 40 becomes low temperature which is below the flexible temperature, the phenomenon called the cold offset such that the toner image is not fixed on the recording material P and the toner is deposited on the fixing roller 40 generates, and can become a cause of generation of the image defect. Further, when the toner deposited on the fixing roller 40 is deposited on a subsequent recording material P, image contamination generates. Further, in the case where the user continues image formation without noting the generation of the cold offset, the toner can be deposited on, in addition to the fixing roller 40, the cleaning unit 60 and the external heating belt 80e and the like. In such a state, when the operation of the fixing device 9 is stopped, and the fixing device 9, specifically the fixing roller 40, the cleaning unit 60, the external heating belt 80e and the like are cooled, the toners deposited thereon stick. When the toners stick to these members, when the fixing device 9 is operated again, there is a large liability that the fixing roller 40, the cleaning unit 60, the external heating belt 80e and the like are damaged.

Therefore, in the case where the surface temperature of the fixing roller 40 can abruptly lower, there is a need to improve followability to the lowering in surface temperature of the fixing roller 40 and the surface temperature of the fixing roller 40 is quickly increased up to a temperature exceeding at least the fixable temperature.

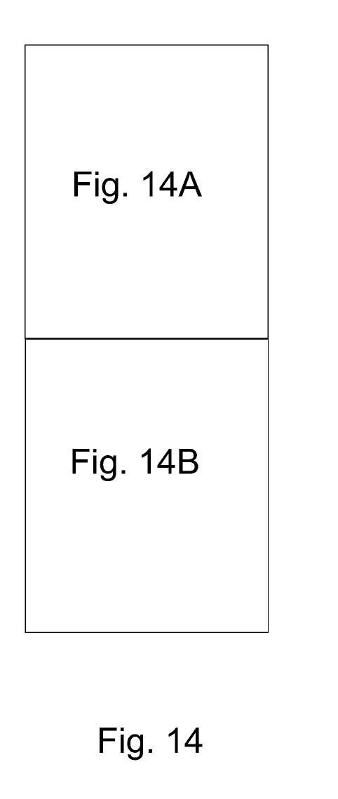

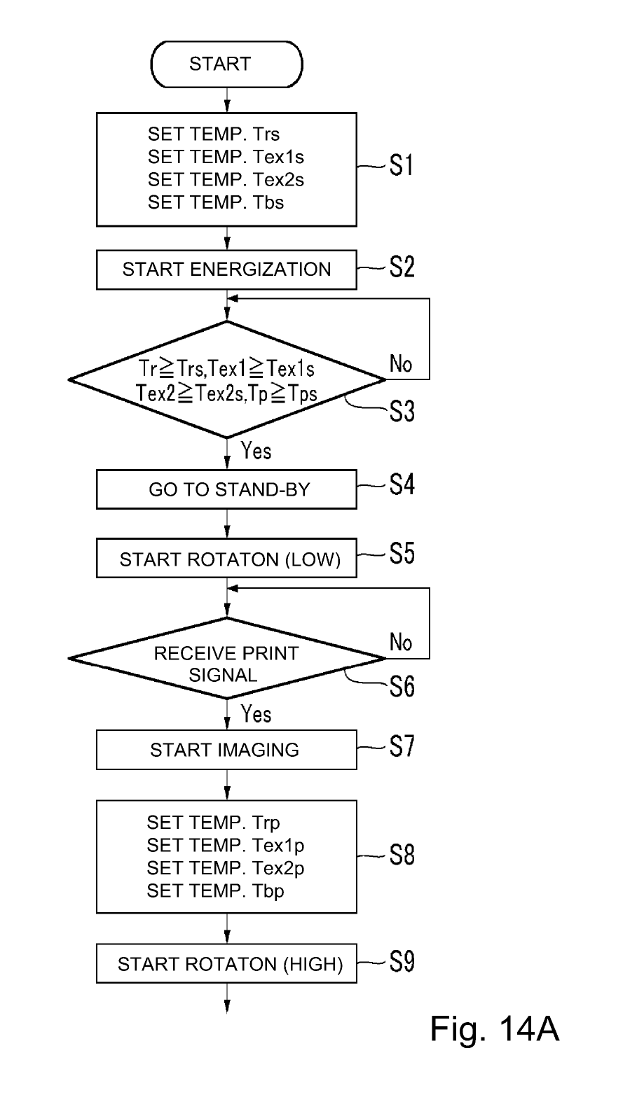

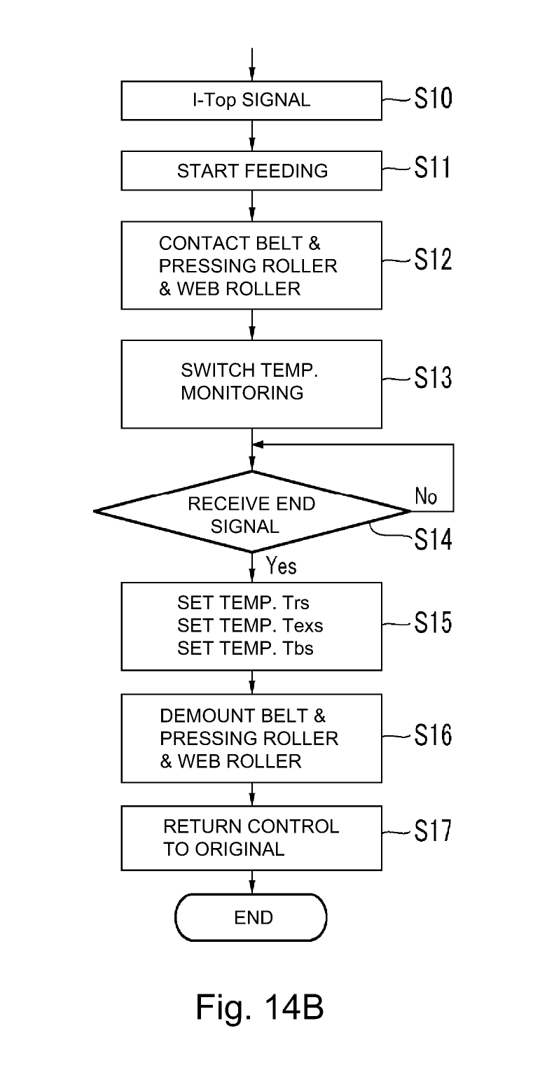

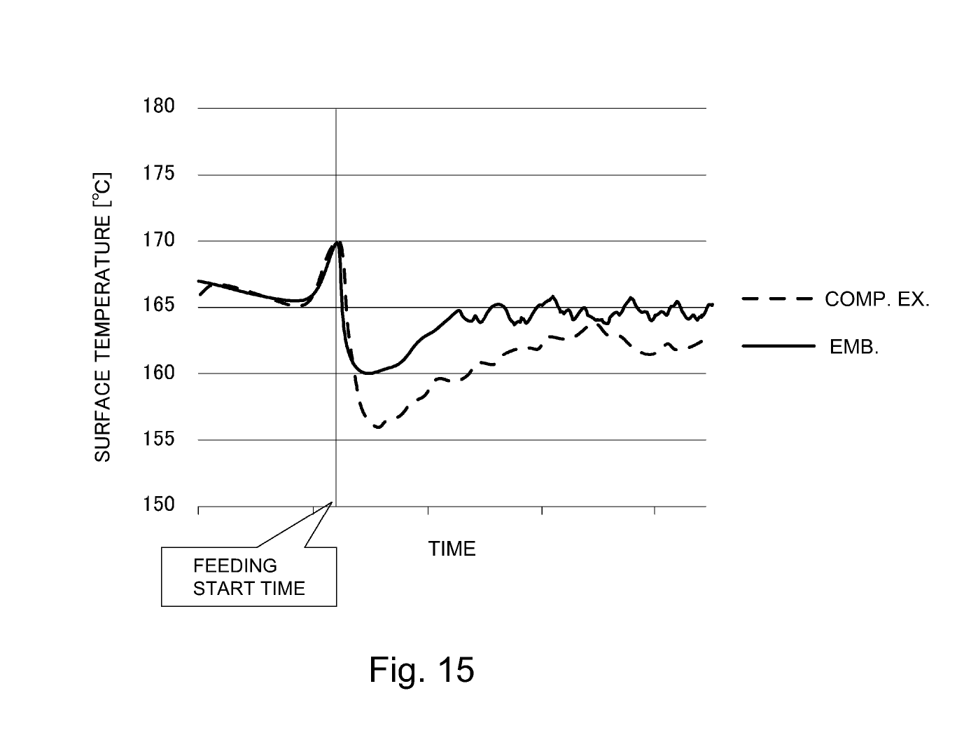

In the image forming apparatus 100, during image formation, both of the halogen heaters 80c and 80d were simultaneously subjected to the ON-OFF control on the basis of only the temperature detected by the thermistor 81b. In the following, description will be made using FIGS. 14 and 15 while appropriately making reference to FIGS. 2 and 3. FIG. 14 (14A, 14B) is a flowchart showing control (mode) of the fixing device. This control of the fixing device is started in synchronism with the tuning-on of the power source of the apparatus main assembly by the controller 50, and is ended in synchronism with an end of the image forming job. Incidentally, here, the case where the user sets the thick paper of 250 g/m² in basis weight as the sheet type and an image forming job for carrying out continuous image formation on a large number of sheets of the thick paper is taken as an example and will be described.

As shown in FIG. 5, the controller 50 set a target temperature Trs of the fixing roller temperature, a target temperature Tex1s of the external heating upstream temperature, a target temperature Tex2s of the external heating downstream temperature and a target temperature Tbs, of the surface temperature of the pressing roller 41, which are to be used during stand-by (S1). From the above-described Table 1, the target temperature Trs of the fixing roller temperature used during stand-by is set at 165° C., and the target temperature Tex1s of the external heating upstream temperature and the target temperature Tex2s of the external heating downstream temperature which are used during stand-by are set at 190° C. Further, the target temperature Tbs of the surface temperature of the pressing roller 41 is set at 100° C.

The controller 50 starts energization to the respective halogen heaters 40a, 41a, 80c and 80d of the fixing device 9 (S2). That is, the controller 50 carries out control for energizing (turning on) the halogen heaters 40a, 41a, 80c and 80d via the heater controller 55 and the heater driver 56. The controller 50 discriminates, after the above-described energization, whether or not the surface temperature of the fixing roller 40, the external heating upstream temperature and the external heating downstream temperature of the external heating belt 80e, and the surface temperature of the pressing roller 41 reach the target temperatures Trs, Tex1s, Tex2s and Tbs, respectively (S3). This discrimination is carried out on the basis of comparison with temperatures detected by the respective thermistors 42a, 81a, 81b and 42. The controller 50 repeats the process of S3 until the above-described respective surface temperatures reach the target temperatures Trs, Tex1s, Tex2s and Tbs, and stand by (NO of S3). That is, the controller 50 controls the energization to the halogen heater 80c so that the detection temperature by the thermistor 81a is the target temperature Tex1s (first target temperature). Further, the controller 50 controls the energization to the halogen heater 80d so that the detection temperature by the thermistor 81b is the target temperature Tex2s (second target temperature). Thus, during preparation of the image formation, pre-heating of the fixing roller 40 is carried out.

In the case where the above-described respective temperatures reach the target temperatures Trs, Tex1s, Tex2s and Tbs, respectively (YES of S3), the controller 50 causes the fixing device 9 to go to the stand-by state (S4), and causes the fixing roller 40 to start rotation at a speed lower than a speed during image formation (S5). The controller 50 controls the driving motor 54 via the motor controller 52 and the motor driver 53 and causes the fixing roller 40 to rotate at a speed which is half of a predetermined speed (e.g., 500 mm/sec) during image formation, for example. Further, in the case where the fixing device 9 is in during stand-by (stand-by state), the controller 50 subjects the respective halogen heaters to the ON/OFF control so as to maintain the target temperatures Trs, Tex1s, Tex2s and Tbs, and thus effect temperature adjustment.

The controller 50 discriminates whether or not the print signal is received (S6). The controller 50 repeats the process of S6 until the print signal is received and stands by (NO of S6). In the case where the print signal is received (YES of S6), the controller 50 starts image formation (S7). Then, the controller 50 changes the respective target temperatures to a target temperature Trp of the fixing roller temperature, a target temperature Tex1p of the external heating upstream temperature, a target temperature Tex2p of the external heating downstream temperature and a target temperature Tbp of the surface temperature of the pressing roller 41, which are to be used during image formation (S8). From the above-described Table 1, the target temperature Trp of the fixing roller temperature used during image formation is changed to 170° C., and the target temperature Tex1p of the external heating upstream temperature and the target temperature Tex2p of the external heating downstream temperature which are used during image formation are changed to 215° C. Incidentally, the target temperature Tbp of the surface temperature of the pressing roller 41 is 100° C. as it is.

The controller 50 causes the fixing roller 40 to be rotationally driven so that the speed increases up to the predetermined speed (e.g., 500 mm/sec) during image formation (S9). Further, the controller 50 starts feeding of the recording material P, depending on receipt of an image writing signal (hereinafter, referred to as an I-Top signal (S10), by using a receiving time of an I-Top signal as a reference time (S11). At this time, the feeding of the recording material P may be started irrespective of whether or not the fixing roller temperature, the external heating upstream temperature, the external heating downstream temperature and the surface temperature of the pressing roller 41 reach the target temperatures changed in the above-described S8. This is for the following reason. That is, when the surface temperatures reach the target temperatures, the halogen heaters are turned off, and thereafter the recording material P reaches the fixing nip N1 in some instances. In that case, core metal temperatures of the respective rollers lower, and therefore particularly when the recording materials P are continuously fed, the fixing roller temperature can be below a predetermined temperature necessary to fix the toner (image) on the recording material P, i.e., the target temperature. The above is because improper toner fixing on the recording material P due to such a temperature lowering of the fixing roller temperature is avoided.

When the sheet feeding is started, the controller 50 causes the external heating belt 80e, the pressing roller 41 and the web roller 63 to be pressed against and contacted to the fixing roller 40 on the basis of the receiving time of the I-Top signal before the recording material P reaches the fixing nip N1 (S12). That is, the external heating belt 80e, the pressing roller 41 and the web roller 63 are moved to a state in which the respective members are contacted to the fixing roller, i.e., a contact state by the belt mounting and demounting mechanism, the pressing mounting and demounting mechanism and the web mounting and demounting mechanism.

Then, the controller 50 changes the temperature control of the external heating belt 80e so as to be carried out on the basis of only the temperature detected by the thermistor 81b for detecting the external heating downstream temperature (S13). That is, when detection that the external heating belt 80e is in the contact state is made, the controller 50 switches, on the basis of the temperature detected by the thermistor 81b, both of the halogen heaters 80c and 80d simultaneously so as to be subjected to the ON-OFF control. More specifically, the halogen heater 80c in the upstream side with respect to the rotational direction of the fixing roller 40 is switched, on the basis of the detection temperature of the thermistor 81b in the downstream side with respect to the rotational direction of the fixing roller 40, simultaneously with the halogen heater 80d so as to be subjected to the ON-OFF control. In this case, the controller 50 controls the energization to the halogen heater 80d simultaneously with control of the energization to the halogen heater 80c so that the detection temperature by the thermistor 81a is the target temperature Tex1s. Incidentally, even in the case where the temperature control of the external heating belt 80e is switched to control based on only the thermistor 81b as described above, the controller 50 monitors, on the basis of the temperature detected by the thermistor 81a, whether or not there is no abnormality in external heating downstream temperature. In the case where there is an abnormality in external heating upstream temperature, the controller 50 causes the display portion of the operating portion S to display an error and notifies the user of the abnormality, for example.

The controller 50 discriminates whether or not an image formation end signal is received (S14). In the case where the image formation end signal is received (YES of S14), the controller 50 changes the respective target temperatures to the target temperatures Trs, Tex1s, Tex2s and Tbs during stand-by (S15). Then, the controller 50 causes the external heating unit 80, the pressing roller 41 and the web roller 63 to be spaced from the fixing roller 40 and be placed in the spaced state, by the belt mounting and demounting mechanism, the pressing mounting and demounting mechanism and the web mounting and demounting mechanism (S16). That is, the controller 50 causes the fixing device 9 to go to the stand-by state. In the case of the stand-by state, these members are kept in the contact state, deformation and distortion of the elastic layers at the fixing nip N1 and the external heating contact portion N2 remain, so that lateral stripes, glossy stripes (uneven glossiness) and the like generate and thus an image quality can lower. In order to avoid this, in the stand-by state, the external heating unit 80, the pressing roller 41 and the web roller 63 are spaced from the fixing roller 40.

When the controller 50 causes the fixing device 9 to go to the stand-by state, the controller 50 returns the temperature control of the external heating belt 80e only by the thermistor 81b changed in the above-described S13 to that before the change (S17). That is, when the controller 50 detects that the external heating belt 80e is in the spaced state, the controller 50 returns the temperature control of the external heating belt 80e to the original temperature control. That is, the controller 50 returns the temperature control of the external heating belt 80e so that the temperature control is not effected on the basis of only the temperature detected by the thermistor 81b for detecting the external heating downstream temperature but is effected on the basis of the temperatures detected by the thermistors 81a and 81b. Thus, in the case where the external heating belt 80e is in the spaced state, the control of the halogen heater 80c is carried out on the basis of the temperature detected by the thermistor 81a and the control of the halogen heater 80d is carried out on the basis of the temperature detected by the thermistor 81b.

In FIG. 15, in the case where image formation is carried out on a large number of sheets of thick paper (basis weight: 250 g/m² as an example) by using a fixing device in this embodiment, a time progression of the fixing roller temperature detected by the thermistor 42a. However, for the purpose of easy understanding, also a time progression of the fixing roller temperature detected by the thermistor 42a in the case where image formation is carried on a large number of sheets of thick paper (basis weight: 250 g/m² as an example) by using a fixing device in a comparison example is shown. In FIG. 15, the ordinate represents the surface temperature and the abscissa represents the time.

When the recording material P enters the fixing nip N1 for toner fixing (see feeding start time), the heat transfers from the fixing roller 40 to the recording material P, so that the fixing roller temperature lowers. As can be understood from FIG. 15, in the fixing device 9 in this embodiment, the fixing roller temperature only lowers to about 160° C., but in the fixing device 9 in the comparison example, the fixing roller temperature lowers to about 155° C. That is, it is understood that in the fixing device 9 in this embodiment, the lowering in surface temperature of the fixing roller can be suppressed.

As described above, during image formation, the halogen heater 80c in the upstream side with respect to the rotational direction of the fixing roller 40 is ON-OFF controlled, on the basis of the detection temperature of the thermistor 81b in the upstream side with respect to the rotational direction of the fixing roller 40, simultaneously with the halogen heater 80d. That is, during image formation, the ON-OFF control of the halogen heater 80c is not carried out on the basis of the surface temperature, lower than the belt surface temperature in the upstream side with respect to the rotational direction of the fixing roller 40, delayed in temperature lowering compared with the surface temperature in the downstream side with respect to the rotational direction of the fixing roller 40. By doing so, it is possible to quickly carry out the heat supply to the fixing roller 40 from the external heating belt 80e, particularly from the halogen heater 80c in the upstream side with respect to the rotational direction of the fixing roller 40. For that reason, even in the case where the surface temperature of the fixing roller 40 can abruptly lower, the lowering in surface temperature of the fixing roller can be suppressed. By this, it is possible to lower a possibility that image defects such as fixing non-uniformity, uneven glossiness and color unevenness.

### Fifth Embodiment

Incidentally, the user erroneously sets the recording material P with a basis weight larger than a set basis weight and executes the image forming job in some instances. For example, such a case that plain paper of 81 g/m² in basis weight and thick paper of 240 g/m² in basis weight exist in mixture although the plain paper of 81 g/m² in basis weight is set as the recording material P exists. In this case, the thick paper of 240 g/m² in basis weight is fed substantially to the plain paper of 81 g/m² in basis weight, and therefore, image formation on the thick paper is carried out subsequently to the plain paper. When the recording material P changes from the plain paper to the thick paper, the quantity of the heat transferred from the fixing roller 40 to the recording material P increases. For that reason, supply of the heat from the external heating unit 80 to the fixing roller 40 cannot catch up with the transfer of the quantity of the heat, with the result that the image formation on the thick paper is carried out while the surface temperature of the fixing roller 40 is lower than the target temperature necessary for the fixing. In the following, this point will be described.

First, in Table 6, a lowest (point) temperature in the case where although the plain paper of 81 g/m² in basis weight is set as the recording material P, the recording material P with a basis weight of 81 g/m² or more is fed during image formation and the surface temperature of the fixing roller 40 is lowest is shown for each of basis weights of the recording materials P.

TABLE 6

| | Recording material basis weight (g/m²) | | | | |
|---|---|---|---|---|---|
| | 81 | 100 | 150 | 200 | 240 |
| FRLT*¹ | 167 | 165 | 160 | 155 | 150 |

*¹“FRLT” is the fixing roller lowest temperature.

In the case where the plain paper of 81 g/m² in basis weight which is the same as user setting is fed, the respective halogen heaters 80c and 80d are individually controlled so that the external heating upstream temperature and the external heating downstream temperature detected by the thermistors 81a and 81b are 210° C. (see Table 1). However, with image formation on a large number of sheets of the recording material P, the external heating downstream temperature detected by the thermistor 81b gradually lowers and is maintained at 208° C., for example. This is due to supply of the heat from the external heating belt 80e to the fixing roller 40 at the external heating contact portion (nip). Further, with an increasing basis weight, heat transferred from the fixing roller 40 to the recording material P is larger, and therefore, as shown in Table 2, with a larger basis weight of the fed recording material P than the basis weight set by the user, the external heating downstream temperature detected by the thermistor 81b becomes lower.

FIG. 7 is a graph showing a temperature difference (Tex1−Tex2) between a detection temperature Tex1 of the thermistor 81a and a detection temperature Tex2 of the thermistor 81b in the case where the thick paper of 240 g/m² in basis weight is fed subsequently to the plain paper of 81 g/m² in basis weight and the image formation is carried out.

As shown in FIG. 7, when the recording material P with the basis weight of 81 g/m² is fed and the image formation is started, the temperature difference (Tex1−Tex2) gradually extends from a state of 0° C. and is maintained at 2° C. This fixing device generates with supply of the heat from the external heating belt 80e to the fixing roller 40 lowering in temperature by heat transfer to the recording material P, and therefore, is unchanged and stabilized in the case where the recording materials P with the same basis weight are continuously fed. However, when the recording material P with the basis weight of 240 g/m² is fed, the fixing roller temperature further lowers, to that the heat supplied from the external heating belt 80e to the recording material P increases. Then, the temperature of the detection temperature Tex2 of the thermistor 81b lowers compared with the case of the recording material P with the basis weight of 81 g/m², and therefore, the temperature difference with the detection temperature Tex1 of the thermistor 81a extends to 10° C.

In Table 7, an upper-limit temperature (allowable upper-limit temperature) and a lower-limit temperature (fixable temperature) of the surface temperature, of the fixing roller 40, appropriate for the toner fixing on the recording material P are shown for each of basis weights of the recording materials P.

TABLE 7

| | Recording material basis weight (g/m²) | | | | | |
|---|---|---|---|---|---|---|
| | 60-79 | 80-99 | 100-149 | 150-179 | 180-199 | 200-249 |
| AULT*¹ (° C.) | 175 | 180 | 185 | 190 | 195 | 200 |
| FT*² | 135 | 140 | 147 | 153 | 155 | 157 |

*¹“AULT” is the allowable upper-limit temperature.
*²“FT”is the fixable temperature.

As described above, for example, when the recording material P with a large basis weight is fed in the case where the user setting is the basis weight of 81 g/m², the surface temperature of the fixing roller 40 is below the fixable temperature necessary for the toner fixing. That is, when the recording material P with the basis weight of 240 g/m² is fed in the case where the user setting is the basis weight of 81 g/m², the lowest temperature of the fixing roller 40 is 150° C. (see Table 2) and is below the fixable temperature of 157° C. (see Table 3) at the time of the recording material P with the basis weight of 240 g/m².

However, when the surface temperature of the fixing roller 40 is kept at a low temperature which is below the fixable temperature, as described above, the toner image is not fixed, and a phenomenon which is called a cold offset such that the toner is deposited on the fixing roller 40 generates can cause the image defect. Further, when the toners deposited on the fixing roller 40, the cleaning unit 60, the cleaning unit 60, the external heating belt 80e and the like stick, the toners can damage the fixing roller 40, the cleaning unit 60, the external heating belt 80e and the like. Therefore, in the case such that the recording material P different in various pieces of information (for example, the basis weight) from the recording material P set by the user is fed during image formation, there is a need to increase the surface temperature of the fixing roller 40 up to a temperature exceeding at least the fixable temperature.

Therefore, in the following, a fixing device for solving the above-described problem will be described. However, a constitution and a control system of the fixing device 9 according to this embodiment are similar to those in the above-described Fourth Embodiment (see FIGS. 2 and 3), and therefore will be omitted from description.

Here, in Table 8, respective target temperatures (represented as setting temperatures in the table) of the fixing roller 40 and the external heating belt 80e which are used during stand-by and during image formation are shown. The controller 50 subjects, as described above, the halogen heaters 40a and 41a and the halogen heaters 80c and 80d to the ON-OFF control, and adjusts the surface temperature of the external heating belt 80e, and by extension to the surface temperature of the fixing roller 40, to the target temperatures shown in Table 4. As can be understood from Table 4, the target temperatures of the fixing roller 40 and the external heating belt 80e are determined depending on the basis weight of the recording material P. Further, a turning-on duty (turning-on ratio) of the external (heating) heater, i.e., the halogen heaters 80c and 80d is different for each of basis weights of the recording materials P. Incidentally, in the fixing device according to Second Embodiment, the controller 50 effects control for energizing the halogen heaters 80c and 80d in accordance with the turning-on duty.

TABLE 8

| | Recording material basis weight (g/m²) | | | | | |
|---|---|---|---|---|---|---|
| | 60-79 | 80-99 | 100-149 | 150-179 | 180-199 | 200-249 |
| FRST*¹ | 165 (° C.) | | | | | |
| TDSB*² | | | | | | |
| FRST*¹ | 170 (° C.) | | | | | |
| TDIF*³ | | | | | | |
| EHBST*⁴ | 190 (° C.) | | | | | |
| TDSB⁺² | | | | | | |
| EHBST*⁴ | 210 (° C.) | | | | | |
| TDIF*³ | | | | | | |
| EHTOD*⁵ | 40 | 40 | 80 | 80 | 90 | 100 |
| (%) | | | | | | |

*¹“FRST” is the fixing roller setting temperature.
*²“TDSB” is the temperature during stand-by.
*³“TDIF” is the temperature during image formation.
*⁴“EHBST” is the external heating belt setting temperature.
*⁵“EHTOD” is the external heater turning-on duty.

The above-described “turning-on duty” represents a proportion of a time, in which the halogen heaters 80c and 80d are energized in actuality, of a predetermined time in the case where energization to the halogen heaters 80c and 80d for a predetermined time (for 5 seconds, for example). In FIG. 8, a relationship of the turning-on duty with an energization time and a non-energization time of the halogen heaters 80c and 80d was shown. In FIG. 8, the ordinate represents the turning-on duty (%), and the abscissa represents the time (seconds). As shown in FIG. 8, for example, in the case where the turning-on duty is 60%, it is shown that of 5 seconds, for the first 3 seconds, the energization is made (ON), and for the remaining 2 seconds, the energization is not made (OFF, non-energization).

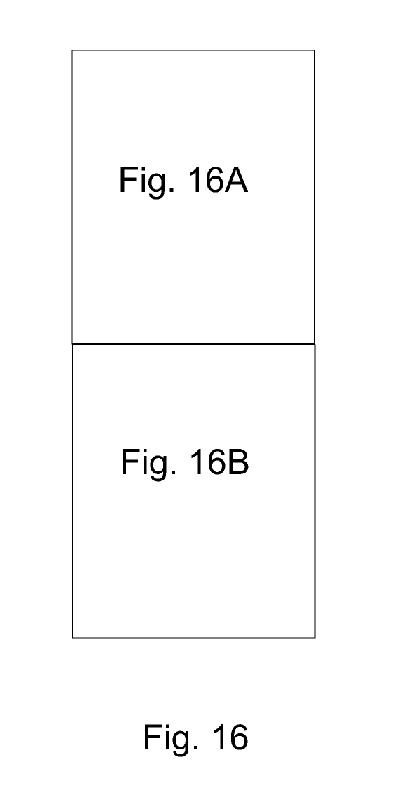

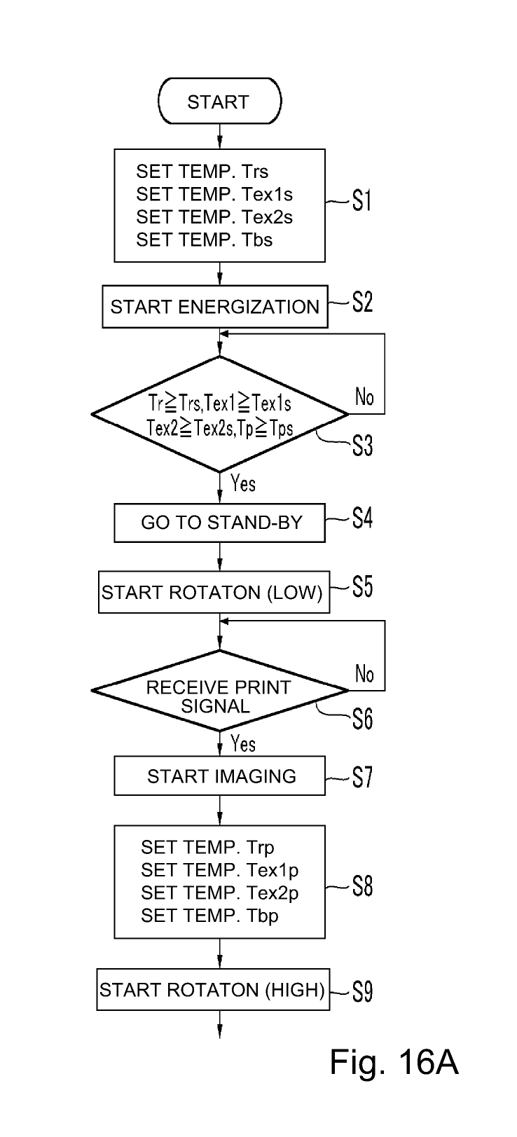

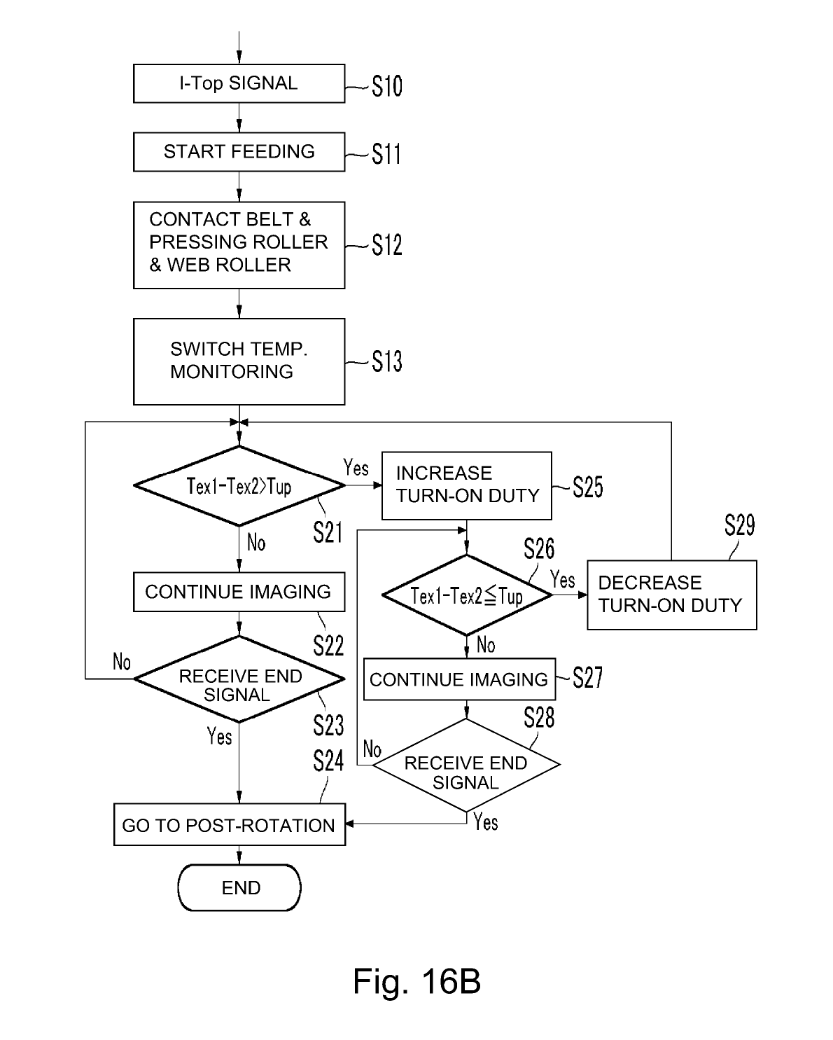

FIG. 16 is a flowchart showing the control of the fixing device in Second Embodiment. However, a portion overlapping in description with the control shown in the above-described FIG. 14 will be omitted from explanation. Further, description will be made by taking, as an example, the case where the thick paper with the basis weight of 240 g/m² was fed during image formation although the plain paper with the basis weight of 81 g/m² is set as the recording material P.

As shown in FIG. 16 (16A, 16B), the controller 50 starts, after a process of S1 is executed, energization to the respective halogen heaters 40a, 41a, 80c and 80d of the fixing device (S2). However, the turning-on duty of the halogen heaters 80c and 80d in this case is 100% irrespective of the basis weight set by the user. That is, the halogen heaters 80c and 80d are always energized. Thereafter, the controller 50 executes respective processes of S3 to S7.

The controller 50 changes the respective target temperatures to a target temperature Trp of the fixing roller temperature, a target temperature Tex1p of the external heating upstream temperature, a target temperature Tex2p of the external heating downstream temperature and a target temperature Tbp of the surface temperature of the pressing roller 41, which are to be used during image formation (S8). From the above-described Table 4, the target temperature Trp of the fixing roller temperature used during image formation is changed to 170° C., and the target temperature Tex1p of the external heating upstream temperature and the target temperature Tex2p of the external heating downstream temperature which are used during image formation are changed to 210° C. The target temperature Tbp of the surface temperature of the pressing roller 41 is 100° C. At this time, the turning-on duty is changed to 40% in accordance with the setting for the basis weight of 81 g/m², and the halogen heaters 80c and 80d are energized. That is, the halogen heaters are repetitively energized for 2 seconds with an interval of 3 seconds.

After execution of the respective processes S9 to S12, the controller 50 changes the temperature control of the external heating belt 80e so as to be carried out on the basis of only the temperature detected by the thermistor 81b for detecting the external heating downstream temperature (S13). That is, in the case where the contact state of the external heating belt 80e is detected, the controller 50 causes, on the basis of the temperature detected by the thermistor 81b, both of the halogen heaters 80c and 80d simultaneously so as to be subjected to the ON-OFF controllable. However, in this Second Embodiment, even when the halogen heaters 80c and 80d are simultaneously subjected to the ON control, these heaters 80c and 80d are to be repetitively subjected to the energization (ON) and the non-energization (OFF) with a predetermined time interval in accordance with the turning-on duty. By this, the overshooting of the surface temperature of external heating belt 80e after the image formation can be suppressed.

The controller 50 discriminates whether or not the temperature difference (Tex1−Tex2) between the detection temperature Tex1 of the thermistor 81a and the detection temperature Tex2 of the thermistor 81b is larger than a temperature difference Tup (4° C., for example) as a first predetermined value (S21). In the case where the temperature difference (Tex1−Tex2) is not more than the first predetermined value, i.e., not more than the predetermined temperature difference Tup (NO of S21), the controller 50 continues image formation without changing the turning-on duty of the halogen heaters 80c and 80d from 40% (S22). That is, in this case, the temperature of the detection temperature Tex2 of the thermistor 81b does not largely lower, so that the temperature difference with the detection temperature Tex1 of the thermistor 81a is small. For that reason, there is a small liability that the surface temperature of the fixing roller 40 becomes a low temperature which is below the fixable temperature, so that there is no need to carry out control of increasing the external heating downstream temperature in order to increase the surface temperature of the fixing roller 40, i.e., control of increasing the turning-on duty of the halogen heater 80d.

The controller 50 discriminates whether or not a print end signal is received (S23), and in the case where the print end signal is not received (NO of S23), the process is returned to the process of the above-described S21. In the case where the print end signal is received (YES of S23), a post-rotation operation is performed (S24), and the process is ended. In the post-rotation operation in this embodiment, the controller 50 executes the above-described process S15 to S17 of FIG. 14. That is, the controller 50 changes the respective target temperatures to the target temperatures Trs, Tex1s, Tex2s and Tbs during stand-by (S15). Then, the controller 50 causes the external heating unit 80, the pressing roller 41 and the web roller 63 to be spaced from the fixing roller 40 and be placed in the spaced state (S16). The controller 50 returns the temperature control of the external heating belt 80e only by the thermistor 81a to the temperature control before the change (S17).

On the other hand, in the case where the temperature difference (Tex1−Tex2) is larger than the predetermined temperature difference Tup (YES of S21), the controller 50 increases the turning-on duty of the halogen heater 80d of those of the halogen heaters 80c and 80d (S25). For example, the controller 50 increases the turning-on duty, which was 40%, up to 100%. That is, in this case, the temperature of the detection temperature Tex2 of the thermistor 81b largely lowers, so that the temperature difference with the detection temperature Tex1 of the thermistor 81a becomes large. For that reason, there is a liability that the surface temperature of the fixing roller 40 becomes a low temperature which is below the fixable temperature. Therefore, in order to increase the surface temperature of the fixing roller 40, control of increasing the external heating downstream temperature, i.e., control of increasing the turning-on duty of the halogen heater 80d is effected.

The controller 50 discriminates whether or not the temperature difference (Tex1−Tex2) is not more than the predetermined temperature difference Tup after the process of S25 (S26). In the case where the temperature difference (Tex1−Tex2) is larger than the predetermined temperature difference Tup (NO of S26), the controller 50 continues the image formation without returning the turning-on duty of the halogen heater 80d from 100%, after the change, to the original value (S27). That is, in a period in which the temperature difference (Tex1−Tex2) is larger than the predetermined temperature difference Tup, there is a liability that the surface temperature of the fixing roller 40 becomes low temperature which is below the fixable temperature, and therefore, there is a need to subsequently increase the external heating downstream temperature. For that reason, the halogen heater 80d is energized in accordance with the increased turning-on duty after the change.

The controller 50 discriminates whether or not a print end signal is received (S28), and in the case where the print end signal is not received (NO of S28), the process is returned to the process of the above-described S26. In the case where the print end signal is received (YES of S28), a post-rotation operation is performed (S24), and the process is ended. In the post-rotation operation in this embodiment, the controller 50 executes the process S15 to S17 of FIG. 5 as described above.

In the above-described process of S26, in the case where the temperature difference (Tex1−Tex2) is not more than the predetermined temperature difference Tup (YES of S26), the controller 50 returns the turning-on duty of the halogen heater 80d to the turning-on duty before the change (S29). For example, the controller 50 decreases the turning-on duty, which was 100%, to 40%. That is, control of increasing the turning-on duty of the halogen heater 80d (see S25), and therefore, the external heating downstream temperature increases, so that the surface temperature of the fixing roller 40 becomes a temperature exceeding the fixable temperature. However, when the surface temperature of the fixing roller 40 is further increased, the fixing roller 40 or the like can be broken. Therefore, the turning-on duty of the halogen heater 80d is decreased and returned to the original value, whereby a further increase in surface temperature of the fixing roller 40 is suppressed. After the process of S29, the process is returned to the above-described process of S21, and the controller 50 repeats the processes of S21 to S29.

As described above, also in Second Embodiment, during image formation, the halogen heater 80c in the upstream side with respect to the rotational direction of the fixing roller 40 is ON-OFF controlled, on the basis of the detection temperature of the thermistor 81b in the downstream side with respect to the rotational direction of the fixing roller 40, simultaneously with the halogen heater 80d. Then, on the basis of a difference in detection temperature between the two thermistors 81a and 81b, control of increasing the turning-on duty of the halogen heater 80d is carried out in the case where the heat quantity supplied from the external heating belt 80e to the fixing roller 40 is insufficient. By this, during image formation, the recording material P is changed from the plain paper to the thick paper, for example, and even when the quantity of the heat transferred from the fixing roller 40 to the recording material P is increased, it is possible to carry out sufficient heat supply from the external heating unit 80 to the fixing roller 40. For that reason, the image formation on the thick paper is not effected while making the surface temperature of the fixing roller 40 lower than a necessary target temperature. Accordingly, the image defect due to the generation of the cold offset is not readily generated.

Incidentally, in Fifth Embodiment, in the case where the temperature difference (Tex1−Tex2) is larger than the predetermined temperature difference Tup, the turning-on duty of only the halogen heater 80d is changed (see S25), but the present invention is not limited thereto, and the turning-on duty of both of the halogen heaters 80c and 80d may also be changed. In that case, in the above-described process of S26, when the temperature difference (Tex1−Tex2) is not more than the predetermined temperature difference Tup, the turning-on duty of the both of the halogen heaters 80c and 80d is returned to the turning-on duty before the change (S29).

### Sixth Embodiment

Incidentally, when the feeding interval of the recording material P is made longer than a predetermined time during image formation, the number of sheets of the recording materials P fed to the fixing nip N1 per unit time decreases, and therefore, a lowering (degree) of the surface temperature of the fixing roller 40 becomes smaller than an assumed degree. Then, the heat supply from the external heating unit 80 to the fixing roller 40 becomes excessive, so that the surface temperature of the fixing roller 40 can be higher than the target temperature. The toner image fixed on the recording material P at a temperature higher than the target temperature is liable to cause a non-uniformity in gloss and density. Further, when the surface temperature of the fixing roller 40 is high, viscosity of the toner becomes smaller than proper viscosity at which the toner image is fixed on the recording material P. In that case, a phenomenon which is called a hot offset such that the toner image is not fixed on the recording material P and the toner is deposited on the fixing roller 40 generates, so that a problem similar to that in the case where the cold offset as described above generates can arise. In the following, this point will be described using FIGS. 10 and 11.

FIG. 10 shows a time progression of the surface temperature of the fixing roller 40 in the case where the feeding interval of the recording material P (basis weight: 81 g/m² as an example) is longer than a predetermined time during image formation. In this case, during image formation, the respective halogen heaters 40a, 41a, 80c and 80d are controlled so that the surface temperature of the fixing roller 40 (fixing roller temperature) is the target temperature of 170° C. (see Table 4). However, when the feeding interval of the recording material P is longer than the predetermined time, the quantity per unit time of the heat transferred from the fixing roller 40 to the recording material P decreases. With this, the heat quantity supplied to the fixing roller 40 relatively becomes large, and therefore, as shown in FIG. 10, the surface temperature of the fixing roller 40 gradually increases and exceeds 180° C. (see Table 3) which is a proper allowable upper-limit temperature for the toner fixing. Then, the phenomenon called the hot offset generates and becomes a cause of generation of the image defect.

FIG. 11 is a graph showing a temperature difference (Tex1−Tex2) between a detection temperature Tex1 of the thermistor 81a and a detection temperature Tex2 of the thermistor 81b in the case where the feeding interval of the recording material P (basis weight: 81 g/m² as an example) is longer than the predetermined time during image formation.

As shown in FIG. 11, in the case where the recording material P is fed with a predetermined time interval, irrespective of the number of sheets of the temperatures P fed to the fixing nip N1 per unit time, the surface temperature of the fixing roller 40 lowers as estimated. For that reason, the temperature difference (Tex1−Tex2) is maintained at 2° C. As described above, this fixing device generates with supply of the heat from the external heating belt 80e to the fixing roller 40 lowering in temperature by heat transfer to the recording material P. For that reason, when the recording materials P are fed with the predetermined feeding interval, the heat transfer to the recording materials P and the heat supply from the external heating belt 80e are balanced with each other on the fixing roller 40, so that the temperature difference (Tex1−Tex2) is unchanged and is stabilized.

However, when the feeding interval of the recording material P is longer than the predetermined time and the number of sheets of the recording materials P fed to the fixing nip N1 per unit time decreases, the temperature difference (Tex1−Tex2) gradually becomes small as shown in FIG. 11. This is because the surface temperature of the fixing roller 40 is increased by the increase in feeding interval of the recording material P. That is, the surface temperature of the fixing roller 40 increases by the decrease in heat quantity transferred to the recording material P, and with this, the heat quantity supplied from the external heating belt 80e to the fixing roller 40 decreases. Then, the surface temperature of the external heating belt 80e is temperature-detected by the thermistor 81b while being high without lowering. In this case, even when the detection temperature Tex1 of the thermistor 81a is unchanged, the detection temperature Tex2 of the thermistor 81b relatively increases, so that the temperature difference (Tex1−Tex2) becomes small.

When during image formation, the temperature difference (Tex1−Tex2) becomes small, i.e., the surface temperature of the fixing roller 40 increases, the hot offset generates, so that the image defect can generate. Therefore, in the case such that the feeding interval of the recording material P is longer than the predetermined time, there is a need to decrease the surface temperature of the fixing roller 40 down to a temperature which is below at least the allowable upper-limit temperature. However, as in the above-described First Embodiment, in the case where the surface temperature of the external heating belt 80e is controlled only by the thermistor 81a during image formation, it becomes difficult to decrease the surface temperature of the fixing roller 40 down to the temperature which is below the allowable upper-limit temperature.

Therefore, in the following, a fixing device according to this embodiment in which the above-described problem is solved will be described. However, a constitution and a control system of the fixing device 9 according to this embodiment are similar to those in the above-described Fourth Embodiment (see FIGS. 2 and 3), and therefore will be omitted from description.

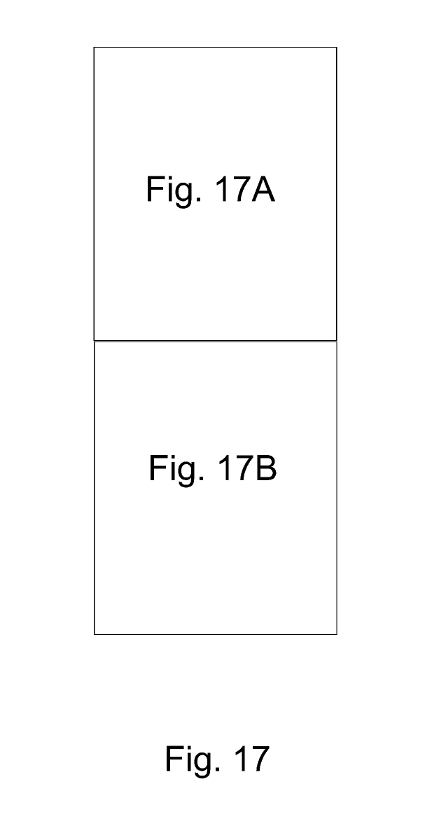

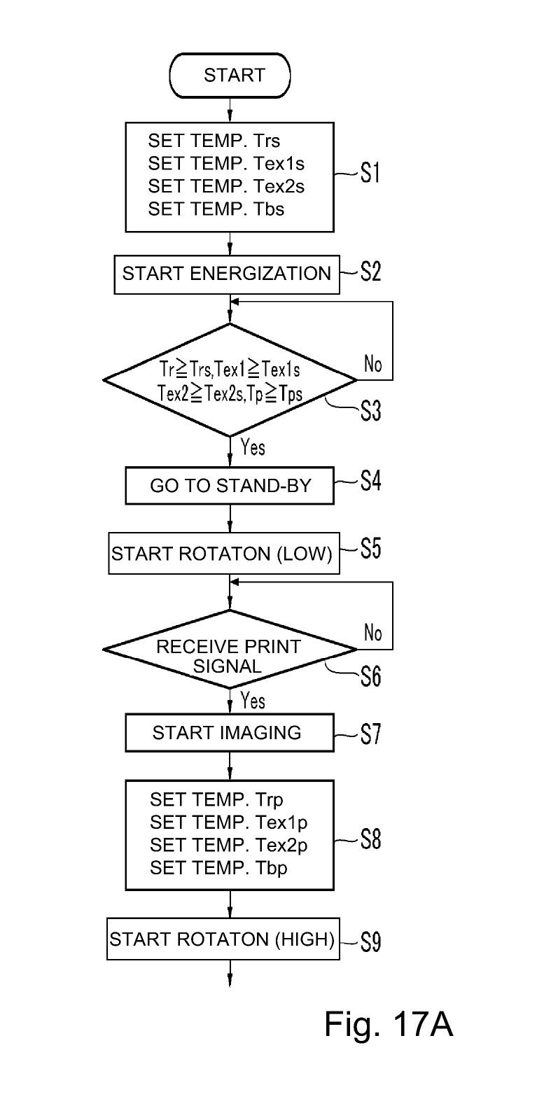

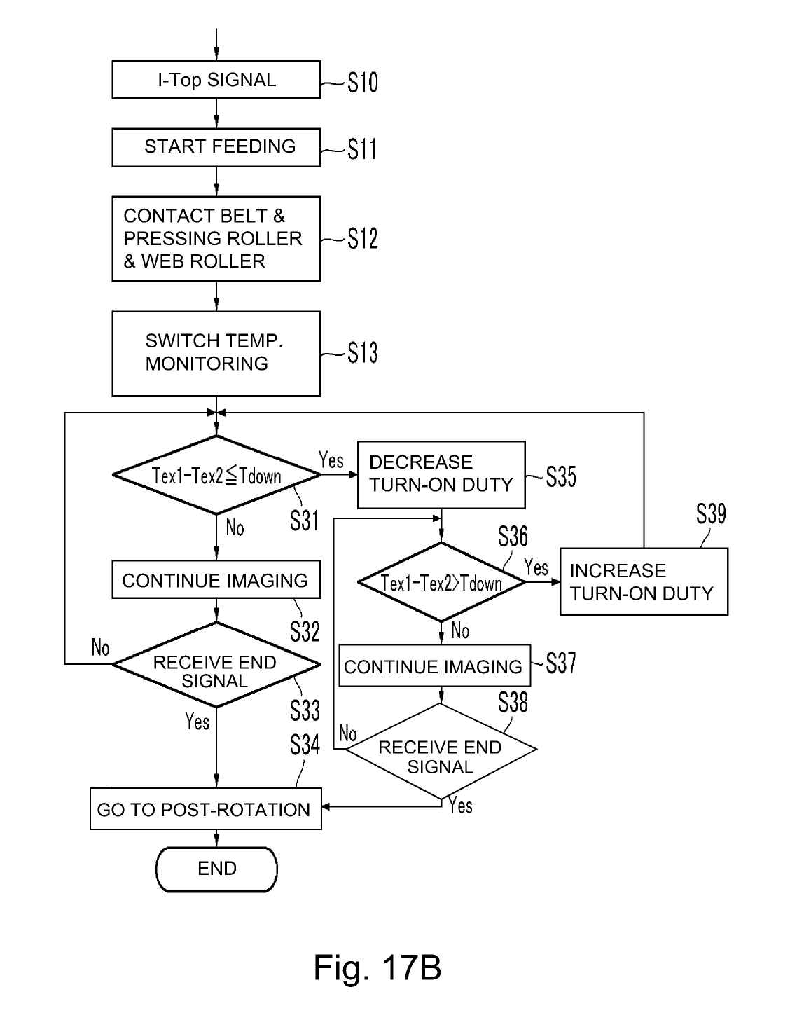

FIG. 17 is a flowchart showing the control of the fixing device in this embodiment. However, a portion overlapping in description with the control shown in the above-described FIG. 14 will be omitted from explanation. Further, description will be made by taking, as an example, the case where the plain paper with the basis weight of 81 g/m² is used as the recording material P during image formation.

As shown in FIG. 17 (17A, 17B), the controller 50 starts, after a process of S1 is executed, energization to the respective halogen heaters 40a, 41a, 80c and 80d of the fixing device (S2). However, the turning-on duty of the halogen heaters 80c and 80d in this case is 100%. Thereafter, the controller 50 executes respective processes of S3 to S7.

The controller 50 changes the respective target temperatures to a target temperature Trp of the fixing roller temperature, a target temperature Tex1p of the external heating upstream temperature, a target temperature Tex2p of the external heating downstream temperature and a target temperature Tbp of the surface temperature of the pressing roller 41, which are to be used during image formation (S8). From the above-described Table 4, the target temperature Trp of the fixing roller temperature used during image formation is changed to 170° C., and the target temperature Tex1p of the external heating upstream temperature and the target temperature Tex2p of the external heating downstream temperature which are used during image formation are changed to 210° C. The target temperature Tbp of the surface temperature of the pressing roller 41 is 100° C. At this time, the turning-on duty is changed to 40% in accordance with the setting for the basis weight of 81 g/m², and the halogen heaters 80c and 80d are energized. That is, the halogen heaters are repetitively energized for 2 seconds with an interval of 3 seconds.

After execution of the respective processes S9 to S12, the controller 50 changes the temperature control of the external heating belt 80e so as to be carried out on the basis of only the temperature detected by the thermistor 81b for detecting the external heating downstream temperature (S13). That is, when the contact state of the external heating belt 80e is detected, the controller 50 causes, on the basis of the temperature detected by the thermistor 81b, both of the halogen heaters 80c and 80d simultaneously so as to be subjected to the ON-OFF controllable. However, in this Third Embodiment, even when the halogen heaters 80c and 80d are simultaneously subjected to the ON control, these heaters 80c and 80d are repetitively subjected to the energization (ON) and the non-energization (OFF) with a predetermined time interval in accordance with the turning-on duty. Thus, the overshooting of the surface temperature of external heating belt 80e after the image formation is suppressed.

The controller 50 discriminates whether or not the temperature difference (Tex1−Tex2) between the detection temperature Tex1 of the thermistor 81a and the detection temperature Tex2 of the thermistor 81b is not more than a temperature difference Tdown (0.3° C., for example) as a second predetermined value (S31). In the case where the temperature difference (Tex1−Tex2) is larger than the predetermined temperature difference Tdown (NO of S31), the controller 50 continues image formation without changing the turning-on duty of the halogen heaters 80c and 80d from 40% (S32). That is, in this case, the temperature of the detection temperature Tex2 of the thermistor 81b does not largely increase, so that the temperature difference with the detection temperature Tex1 of the thermistor 81a is not small. For that reason, there is a small liability that the surface temperature of the fixing roller 40 becomes a high temperature exceeding the allowable upper-limit temperature, so that there is no need to carry out control of decreasing the external heating downstream temperature in order to decrease the surface temperature of the fixing roller 40, i.e., control of decreasing the turning-on duty of the halogen heater 80d.

The controller 50 discriminates whether or not a print end signal is received (S33), and in the case where the print end signal is not received (NO of S33), the process is returned to the process of the above-described S31. In the case where the print end signal is received (YES of S33), a post-rotation operation is performed (S34), and the process is ended. In the post-rotation operation in this embodiment, the controller 50 executes the process S15 to S17 of FIG. 5 as already been described above.

On the other hand, in the case where the temperature difference (Tex1−Tex2) is not more than the second predetermined value, i.e., not more than predetermined temperature difference Tdown (YES of S31), the controller 50 decreases the turning-on duty of the halogen heater 80d of those of the halogen heaters 80c and 80d (S35). For example, the controller 50 decreases the turning-on duty, which was 40%, down to 0%. In the case where the turning-on duty is 0%, the halogen heater 80d is not turned on. That is, in this case, the temperature of the detection temperature Tex2 of the thermistor 81b largely increases, so that the temperature difference with the detection temperature Tex1 of the thermistor 81a becomes small. For that reason, there is a liability that the surface temperature of the fixing roller 40 becomes a high temperature exceeding the allowable upper-limit temperature. Therefore, in order to decrease the surface temperature of the fixing roller 40, control of decreasing the external heating downstream temperature, i.e., control of decreasing the turning-on duty of the halogen heater 80d is effected.

The controller 50 discriminates whether or not the temperature difference (Tex1−Tex2) is larger than the predetermined temperature difference Tdown after the process of S35 (S36). In the case where the temperature difference (Tex1−Tex2) is not more than the predetermined temperature difference Tdown (NO of S36), the controller 50 continues the image formation without returning the turning-on duty of the halogen heater 80d from 0%, after the change, to the original value (S37). That is, in a period in which the temperature difference (Tex1−Tex2) is not more than the predetermined temperature difference Tdown, there is a liability that the surface temperature of the fixing roller 40 becomes high temperature exceeding the allowable upper-limit temperature, and therefore, there is a need to subsequently decrease the external heating downstream temperature. For that reason, the halogen heater 80d is energized in accordance with the decreased turning-on duty after the change.

The controller 50 discriminates whether or not a print end signal is received (S38), and in the case where the print end signal is not received (NO of S38), the process is returned to the process of the above-described S36. In the case where the print end signal is received (YES of S38), a post-rotation operation is performed (S34), and the process is ended. In the post-rotation operation in this embodiment, the controller 50 executes the process S15 to S17 of FIG. 5 as described above.

In the above-described process of S36, in the case where the temperature difference (Tex1−Tex2) is larger than the predetermined temperature difference Tdown (YES of S36), the controller 50 returns the turning-on duty of the halogen heater 80d to the turning-on duty before the change, i.e., the original value (S39). For example, the controller 50 increases the turning-on duty, which was 0%, to 40%. That is, control of decreasing the turning-on duty of the halogen heater 80d (see S35), and therefore, the external heating downstream temperature decreases, so that the surface temperature of the fixing roller 40 becomes a temperature which is below the allowable upper-limit temperature. However, when the surface temperature of the fixing roller 40 is further decreased, there is a liability that the surface temperature becomes a low temperature which is below the fixable temperature. Therefore, the turning-on duty of the halogen heater 80d is increased and returned to the original value, whereby a further decrease in surface temperature of the fixing roller 40 is suppressed. After the process of S39, the process is returned to the above-described process of S31, and the controller 50 repeats the processes of S31 to S39.

As described above, also in Third Embodiment, during image formation, the halogen heater 80c in the upstream side with respect to the rotational direction of the fixing roller 40 is ON-OFF controlled, on the basis of the detection temperature of the thermistor 81b in the downstream side with respect to the rotational direction of the fixing roller 40, simultaneously with the halogen heater 80d. Then, on the basis of a difference in detection temperature between the two thermistors 81a and 81b, control of decreasing the turning-on duty of the halogen heater 80d is carried out in the case where the heat quantity supplied from the external heating belt 80e to the fixing roller 40 is excessive. By this, the feeding interval of the recording material P is longer than the predetermined time, and even when the number of sheets of the recording materials P fed to the fixing nip N1 per unit time is decreased, it is possible to carry out optimum heat supply from the external heating unit 80 to the fixing roller 40. For that reason, the image formation is not effected while making the surface temperature of the fixing roller 40 higher than a necessary target temperature. Accordingly, the image defect with the generation of the hot offset is not readily generated.

Incidentally, in Third Embodiment, in the case where the temperature difference (Tex1−Tex2) is not more than the predetermined temperature difference Tdown, the turning-on duty of only the halogen heater 80d is changed (see S35), but the present invention is not limited thereto, and the turning-on duty of both of the halogen heaters 80c and 80d may also be changed. In that case, in the above-described process of S36, when the temperature difference (Tex1−Tex2) is not more than the predetermined temperature difference Tup, the turning-on duty of the both of the halogen heaters 80c and 80d is returned to the turning-on duty before the change (S39).

Incidentally, in the above-described Fourth to Sixth Embodiments, as regards the halogen heaters 80c and 80d, those having the same normal rated power were used, but the halogen heaters are not limited thereto, and heaters different in normal rated power may also be used. In that case, as the halogen heater 80c, a heater having normal rated power not more than that of the halogen heater 80d is used. This is because when the normal rated power of the halogen heater 80c is larger than that of the halogen heater 80d, in the case where the surface temperature of the fixing roller 40 abruptly lowers, the external heating belt 80e can be excessively heated in the upstream side with respect to the rotational direction of the fixing roller 40. That is, in the case where the normal rated power of the halogen heater 80c is large, the halogen heater 80c is subjected to the ON-OFF control on the basis of the temperature detected by the thermistor 81b, an output of the halogen heater 80c is larger than that in the case of being based on the temperature detected by the thermistor 81a. Then, in the case where the surface temperature of the fixing roller 40 abruptly lowers, the lowering in surface temperature of the fixing roller 40 can be suppressed, but the external heating belt 80e is heated more than necessary, so that thermal deterioration or the like can be caused to generate. In order to avoid this, the halogen heater 80c having the normal rated power which is not more than the normal rated power of the halogen heater 80d is used. Further, each of the halogen heaters 40a, 41a, 80c and 80d may be a single heater having a specific light distribution, but is not limited thereto, and may also include a plurality of heaters having different light distributions.

Incidentally, in the above-described Fourth to Sixth Embodiments, the fixing roller 40 provided with the halogen heater 40a therein was employed, but a constitution in which the fixing roller 40 is not provided with a heater and in which the fixing roller 40 is heated only by the external heating unit 80 may also be employed. Further, in the above-described embodiments, the pressing roller 41 provided with the halogen heater 41a therein was employed, but a constitution in which the pressing roller 41 is not provided with a heater may also be employed. Further, the pressing roller 41 provided with the elastic layer on the core metal was employed, but is not limited thereto, and may also be in other forms, such as a pressing belt, and a pressing roller and a pressing belt which have elastic layer.

Incidentally, in the above-described Fourth to Sixth Embodiments, as the heating means, the halogen heater was employed. However, as the heating means, other heating means, other than the halogen heater, such as a heating means of an electromagnetic induction heating type and a planar heat generating member may also be used. Further, in the above-described Fourth to Sixth Embodiments, to each of the halogen heaters, electric power equal to associated normal rated power is supplied. However, even in the case where electric power less than the normal rated power is supplied, it is only required that values of maximum electric power supplied to the halogen heaters 80c and 80d are made the same and the turning-on duty is changed as desired.

### INDUSTRIAL APPLICABILITY

According to the present invention, there is provided an image heating apparatus capable of controlling an external heating belt to a proper temperature.

1. An image heating apparatus comprising:
a first rotatable member and a second rotatable member for forming a nip for heating a toner image on a recording material;
an endless belt for heating said first rotatable member in contact with an outer surface of said first rotatable member;
a first roller and a second roller, which are provided inside said endless belt in the order named along a rotational direction of said first rotatable member, for supporting said endless belt;
a first heater for heating said first roller;
a second heater for heating said second roller;
a first sensor for detecting a temperature of a region of said endless belt supported by said first roller;
a second sensor for detecting a temperature of a region of said endless belt supported by said second roller; and
a controller for controlling energization to said first heater and said second heater,
wherein said controller is capable of executing a first mode in which the energization to said first heater is controlled using an output of said first sensor and the energization to said second heater is controlled using an output of said second sensor and a second mode in which the energization to said first heater and said second heater is controlled using the output of said first sensor without using the output of said second sensor.

2. An image heating apparatus according to claim 1, further comprising a moving mechanism for moving said endless belt relative to said first rotatable member so that said endless belt is movable between a contact position where said endless belt outputs the outer surface of said first rotatable member and a spaced position where said endless belt is spaced from said first rotatable member,
wherein said controller executes the first mode when said endless belt is in the spaced position and executes the second mode when said endless belt is in the contact position.

3. An image forming apparatus according to claim 2, wherein said endless belt is constituted so that said endless belt is rotated by said first rotatable member when said endless belt is in the contact position and so that said endless belt is stopped when said endless belt is in the spaced position.

4. An image heating apparatus comprising:
a first rotatable member and a second rotatable member for forming a nip for heating a toner image on a recording material;
an endless belt for heating said first rotatable member in contact with an outer surface of said first rotatable member;
a first roller and a second roller, which are provided inside said endless belt in the order named along a rotational direction of said first rotatable member, for supporting said endless belt;
a first heater for heating said first roller;
a second heater for heating said second roller;
a first sensor for detecting a temperature of a region of said endless belt supported by said first roller;
a second sensor for detecting a temperature of a region of said endless belt supported by said second roller; and
a controller for controlling energization to said first heater and said second heater,
wherein said controller is capable of executing a first mode in which the energization to said first heater is controlled using an output of said first sensor and the energization to said second heater is controlled using an output of said second sensor and a second mode in which the energization to said first heater and said second heater is controlled using the output of said second sensor without using the output of said first sensor.

5. An image heating apparatus according to claim 4, further comprising a moving mechanism for moving said endless belt relative to said first rotatable member so that said endless belt is movable between a contact position where said endless belt outputs the outer surface of said first rotatable member and a spaced position where said endless belt is spaced from said first rotatable member,
wherein said controller executes the first mode when said endless belt is in the spaced position and executes the second mode when said endless belt is in the contact position.

6. An image forming apparatus according to claim 5, wherein said endless belt is constituted so that said endless belt is rotated by said first rotatable member when said endless belt is in the contact position and so that said endless belt is stopped when said endless belt is in the spaced position.
